(19) United States
(12) Patent Application Publication
(10) Pub. No.: US 2007/0272218 A1
(43) Pub. Date: Nov. 29, 2007

(54) Controlling evaporative emissions in a fuel system

(75) Inventor: John C. Woody, Caro, MI (US)

Correspondence Address: REISING, ETHINGTON, BARNES, KISSELLE, P.C., P O BOX 4390, TROY, MI, 48099-4390, US

(73) Assignee: Walbro Engine Management, L.L.C.

(21) Appl. No.: 11/881,476

(22) Filed: Jul. 27, 2007

Related U.S. Application Data
(62) Division of application No. 11/135,242, filed on May 23, 2005, now Pat. No. 7,263,981.

(51) Int. Cl. F02M 5/12

(52) U.S. Cl. 123/517

(57) ABSTRACT

Methods and fuel systems to reduce evaporative emissions of a volatile fuel. A fuel tank contains fuel, a carburetor mixes air with the fuel from the fuel tank, and a plurality of fluid paths route fuel amongst and/or between the fuel tank and the carburetor. A valve actuation device stops flow of fuel in one or more of the plurality of fluid paths and the carburetor is adapted to be drained of fuel during engine shutdown to reduce or prevent evaporative emissions from the fuel system. The carburetor is preferably designed so as to minimize a volume of fuel contained therein.

### FIELD OF THE INVENTION

This invention relates generally to volatile fuel storage and delivery systems for internal combustion engines, and more particularly to evaporative emission controls adapted for use with a carburetor.

### BACKGROUND OF THE INVENTION

A fuel storage and delivery system typically includes a fuel tank and a carburetor that are adapted for use in small, internal combustion engine-powered apparatuses. These apparatuses comprise a large consumer market of popular lawn, garden, and marine products, which include hand-held equipment such as hedge trimmers, grass trimmers, and chainsaws and ground-supported equipment such as snow-blowers, generators, water pumps, power washers, sprayers, garden tractors, rototillers, and lawnmowers and marine equipment like inboard and outboard motors and auxiliary generators. In recent years, such products have been improved to reduce engine exhaust emissions, but now emphasis is being placed on improving these products to reduce non-exhaust emissions of volatile fuels and fuel vapors such as gasoline.

Volatile fuel emissions generally include hot soak losses, running losses, and diurnal losses. Hot soak and diurnal losses result from emission of liquid or vaporous fuel and include permeation losses and evaporative losses. Permeation losses occur when fuel vapor permeates through gaskets, fuel lines, or the fuel tank, and such losses are often abated by materials-oriented solutions such as integrating vapor barrier layers within fuel lines and fuel tanks. Evaporative losses occur when liquid fuel evaporates into hydrocarbon vapor and escapes into the atmosphere. Evaporation of liquid fuel into fuel vapor is usually due to volatility of the fuel, vibration of the fuel tank and sloshing of the fuel therein, and temperature fluctuations of the fuel. Evaporative losses most often occur 1) when fuel vapors in a fuel tank are vented to the atmosphere, and 2) when fuel vapors in a carburetor are vented or otherwise escape to the atmosphere.

Fuel vapors are often vented from a fuel tank to the atmosphere to avoid build-up of positive pressure in the fuel tank. Hand-held equipment often uses diaphragm carburetors, which have spring-biased inlet valves that provide automatic shutoff against such positive tank pressures and, thus, do not require outward venting of the fuel tank. But ground-supported equipment typically uses float-bowl carburetors, which become flooded under such positive tank pressures. When an engine with a float-bowl carburetor is operating, fuel flows out of the fuel tank, and the tank vent allows make-up air to enter the tank to replace the fuel and thereby prevent a negative pressure condition therein. When the engine is not operating, however, fuel vapors may be permitted to vent out to the atmosphere from within the fuel tank to limit tank pressure and avoid carburetor flooding.

Fuel tank vapors are typically recovered using a fuel vapor recovery system. Such systems may include a carbon canister having activated charcoal therein that receives fuel vapors through a valve assembly mounted on the fuel tank and that communicates with an intake manifold of the engine. During engine operation, negative pressure in the intake manifold draws fuel vapor out of the carbon canister. The valve assembly usually has a valve that is responsive to the level of liquid fuel in the fuel tank that enables the valve to stay open at a sufficiently low liquid level to permit fuel vapors to flow freely from the tank into the carbon canister. When filling the tank, as the liquid fuel level rises to approach a desired maximum level of fuel, a float is raised to close the valve to prevent liquid fuel from flowing through the valve and into the vapor-receiving canister. While such a system works well, the added cost of the carbon canister and float valve is prohibitive in many applications.

In addition to fuel tank vapor emissions, fuel vapors also tend to escape from a carburetor, particularly when the carburetor temperature increases due to heat soak back from a hot engine following engine shut down and/or when the associated equipment is stored for an extended period of time in an enclosure during warm weather. To illustrate, when a piece of engine-powered equipment is shut down after running at normal operating temperatures, heat continues to transfer from a hot cylinder head of the engine through an intake manifold to the carburetor. Moreover, the equipment may be placed in a storage enclosure with limited or no ventilation, wherein the temperature may fluctuate over a twenty-four hour period from a daytime high exceeding 160 degrees Fahrenheit to a nighttime low of 60 degrees Fahrenheit. Gasoline fuel evaporates over a wide temperature range with significant evaporation starting at around 90 degrees Fahrenheit, with approximately thirty percent by volume evaporating over a temperature increase to 160 degrees Fahrenheit over a 24 hour period, and with about ninety plus percent by volume evaporating over an increase to 350 degrees Fahrenheit over a 24 hour period. In any case, the temperature of the liquid fuel within the carburetor increases dramatically, thereby vaporizing some of the liquid fuel into fuel vapor.

Fuel escapes from some carburetors more readily than others. Hand-held equipment typically includes two-stroke engines having diaphragm carburetors, which tend to yield relatively low evaporative emissions. Unfortunately, however, diaphragm carburetors are not practical for all engine applications because they tend to have limited fuel metering capabilities, thereby leading to operational instability with certain types of engines. Precision fuel metering is generally not required in engines equipped with diaphragm carburetors, because such engines are usually operated in only two throttle settings—idle or wide-open-throttle (WOT)—such as in chainsaw or grass trimmer applications. In contrast, ground-supported equipment typically have engines with float-bowl carburetors that usually have relatively higher fuel metering capabilities to accommodate infinitely variable throttle settings between idle and WOT, but tend to yield relatively higher evaporative emissions for several reasons.

First, the volume of fuel contained in a float bowl of a given float bowl carburetor is usually several times greater than that contained in a metering chamber of a diaphragm carburetor. Commensurately, the total volume of liquid fuel that may be depleted from a float bowl carburetor will be several times greater than that from a diaphragm carburetor.

Second, diaphragm carburetors are not continuously supplied with fuel from the fuel tank when the engine is not operating. In this case, fuel may completely evaporate from within the diaphragm carburetor, but is not continuously replenished with fuel from the fuel tank. This is because a typical diaphragm carburetor has an inlet needle valve that is strongly biased closed to prevent entry of such fuel. The typical float bowl carburetor, however, is continuously supplied with additional liquid fuel from which additional evaporation takes place. This is because a typical float-bowl carburetor has an inlet needle valve that is normally biased open unless the float bowl is filled with liquid fuel to a predetermined level, at which point a float gently raises the inlet needle valve to a closed position. As the liquid fuel vaporizes and escapes from the carburetor float bowl, the float and inlet needle valve drop thereby allowing fresh liquid fuel to enter the float bowl through the float-actuated inlet needle valve under gravity draining from the fuel tank. Hence, hot soak and diurnal losses in a float bowl carburetor are also increased due to these vaporization-replenishment-vaporization cycles.

Third, as indicated above, float-bowl carburetors are more sensitive to fuel inlet pressure than diaphragm carburetors. Consequently, the fuel tank must have as low and constant an internal pressure as possible, yet still support a high enough threshold pressure to minimize fuel vapor loss to the atmosphere. Unfortunately, conventional combination rubber duck bill and umbrella valves, typically associated with diaphragm carburetor fuel systems, tend to suffer from hysteresis. Thus, such valves are not capable of repeatably holding a tank pressure close enough to a predetermined threshold pressure.

In conclusion, equipment manufacturers are in need of a wide range of reliable and comprehensive technological solutions to the problem of hot soak and diurnal evaporative emissions of volatile fuel from a fuel system—particularly those solutions that address various escape routes of vapor emissions and that are robust and affordable to consumers.

### SUMMARY OF THE INVENTION

According to exemplary embodiments, a method and a fuel system are provided for controlling evaporative emissions of volatile fuel. According to the method, liquid fuel is supplied from a fuel tank into a carburetor during operation of an engine. Also, during shutdown of the engine, liquid fuel is stopped from flowing into the carburetor, and liquid fuel is drained out of the carburetor into a receptacle. According to the system, the fuel tank contains liquid fuel, and the carburetor receives the liquid fuel from the fuel tank during operation of the engine and mixes air with the liquid fuel for supply to the engine. Moreover, during shutdown of the engine, a valve actuation device stops flow of fuel from the fuel tank to the carburetor and the carburetor is drained of fuel to reduce or prevent evaporative emissions from the fuel system.

According to preferred aspects of the method and system, the carburetor may be designed so as to minimize a volume of fuel contained therein, and may be drained of fuel by a manually actuated mechanical pump, an automatically actuated mechanical pump, an electric pump, or gravity draining. Likewise, the valve actuation device may be manually or automatically actuated and may be mechanical or electrical.

According to another exemplary embodiment, a carburetor includes a body, a float that is carried by the body and that is movable about a pivot axis. A fuel bowl is carried by the body for containing fuel and includes a closed end that has an inside bottom surface sloped generally downwardly away from the pivot axis. The closed end of the fuel bowl also has a low-lying collection area and a fuel drain outlet disposed substantially at the low-lying collection area to enable substantially complete drainage of fuel out of the fuel bowl.

According to a further exemplary embodiment, a fuel bowl is provided for containing fuel in a carburetor. The fuel bowl includes an open end, a wall portion extending from the open end, and a closed end terminating the wall portion. The closed end includes a low-lying collection area and a fuel drain outlet disposed substantially at the low-lying collection area to enable substantially complete drainage of fuel out of the fuel bowl.

According to an additional embodiment, a fuel pump is adapted to pump fuel out of a fuel bowl of a carburetor. The fuel pump moves fuel from the fuel bowl into a fuel reservoir of the fuel pump during shutdown of an engine, and moves fuel from the fuel reservoir to a fuel tank or back to the carburetor during startup of the engine. To this end, the fuel pump includes a diaphragm that divides an interior into the fuel reservoir on a reservoir side of the diaphragm and an oppositely disposed actuation chamber on an actuation side of the diaphragm. The actuation chamber accumulates pressurized air to displace the diaphragm against the force of a spring to purge the fuel reservoir. A fuel inlet is in communication with the fuel reservoir, and an inlet check valve is in communication with the fuel inlet. Similarly, a fuel outlet is in communication with the fuel reservoir, and an outlet check valve is in communication with the fuel outlet.

According to a further embodiment, a fuel system supplies fuel to an internal combustion engine, and includes a fuel tank for containing fuel therein, a carburetor in fluid communication with and elevated with respect to the fuel tank and containing fuel therein, at least one valve in fluid communication between the fuel tank and the carburetor and being adapted to prevent flow of fuel into the carburetor at least when the internal combustion engine is not operating, and a pump in fluid communication with the carburetor and being adapted to pump fuel to the carburetor substantially during startup and operation of the internal combustion engine.

According to yet another embodiment, a method of reducing evaporative emissions from a carburetor is provided wherein the carburetor includes a fuel bowl, a fuel inlet passage in communication with the fuel bowl, an inlet valve to valve the inlet fuel passage, a float pivotable about a float pivot axis, and a fuel nozzle jet to communicate fuel within the fuel bowl to a fuel nozzle. The method comprises minimizing at least one of the size of the inlet fuel passage or the lateral distance between float pivot axis and at least one of the vertical axis of the inlet fuel passage or the inlet valve, and maximizing at least one of the fuel contact surface area of the float or the lateral distance between the float pivot axis and a fuel buoyancy force associated with the float, wherein the volume of fuel within the fuel bowl is substantially minimized.

At least some of the objects, features and advantages that may be achieved by at least certain embodiments of the invention include providing a method, fuel system, carburetor, and pumps that enable a reduction in the emission to the atmosphere of unburned fuel vapors, permit a carburetor fuel bowl to be drained during engine shutdown, improve control of fluid flow in a fuel system, can be actuated in a variety of ways including at least manual and powered or automatic, can open and close various valves for controlled venting of a fuel tank and controlled supply of fuel to a carburetor, yield a compact construction and arrangement, do not require active operator intervention to reduce evaporative emissions, are adaptable to a wide range of applications, are of relatively simple design and economical manufacture and assembly, rugged, durable, reliable and have a long, useful life in service.

Of course, other objects, features and advantages will be apparent in view of this disclosure to those skilled in the art. Other methods, fuel systems, carburetors, and pumps embodying the invention may achieve more or less than the noted objects, features or advantages.

### BRIEF DESCRIPTION OF THE DRAWINGS

These and other objects, features and advantages of the present invention will be apparent from the following detailed description of the preferred embodiments and best mode, appended claims, and accompanying drawings in which:

FIG. 1 is a side view of a lawn mower that is equipped with a first exemplary embodiment of a fuel system adapted for reduced evaporative emissions;

FIG. 1A is a schematic view of a portion of an exemplary carburetor;

FIG. 2 is a pictorial schematic view of the exemplary fuel system of FIG. 1 including an exemplary embodiment of a carburetor, a fuel shutoff valve, and a first exemplary embodiment of a mechanical pump adapted for use with an engine of the lawn mower of FIG. 1;

FIG. 3 is a cross-sectional view of the carburetor of FIG. 2;

FIG. 4 is an exploded perspective view of a fuel bowl and body of the carburetor of FIG. 3;

FIG. 5 is a cross-sectional view of the mechanical pump of FIG. 2 in an engine off condition for storing fuel therein;

FIG. 6 is a cross-sectional view of the mechanical pump of FIG. 2 in an engine on condition wherein stored fuel has been purged therefrom;

FIG. 7 is a cross-sectional view of a check valve used in the mechanical pump of FIG. 2;

FIG. 8 is a perspective view of a second exemplary embodiment of a mechanical pump for use as an alternative with the fuel system of FIG. 2;

FIG. 9 is a cross-sectional view of the mechanical pump of FIG. 8;

FIG. 10 is a partial exploded view of the mechanical pump of FIG. 8;

FIG. 11 is a cross-sectional view of a third exemplary embodiment of a mechanical pump for use as an alternative with the fuel system of FIG. 2;

FIG. 12 is a side elevational view of a fourth exemplary embodiment of a mechanical pump for use as an alternative with the fuel system of FIG. 2;

FIG. 13 is a top view of the pump of FIG. 12;

FIG. 14 is a cross-sectional view of the pump of FIG. 13, taken along line 14-14 of FIG. 13;

FIG. 15 is a cross-sectional view of the pump of FIG. 13, taken along line 15-15 of FIG. 13;

FIG. 16 is a partially exploded view of the pump of FIG. 12;

FIG. 17 is a top view of a valve plate shown in FIG. 16 of the pump of FIG. 12;

FIG. 18 is a side view of the valve plate of the pump of FIG. 12;

FIG. 19 is a bottom view of the valve plate of the pump of FIG. 12;

FIG. 20 is a bottom view of a rotary valve shown in FIG. 16 of the pump of FIG. 12;

FIG. 21 is an elevational view of the rotary valve of the pump of FIG. 12;

FIG. 22 is a top view of the rotary valve of the pump of FIG. 12;

FIG. 23 is a top view of an exemplary embodiment of a combined carburetor and mechanical pump for use as an alternative with the fuel system of FIG. 2;

FIG. 24 is an end view of the combined carburetor and mechanical pump of FIG. 23;

FIGS. 25 and 26 are partially exploded perspective views of the combined carburetor and mechanical pump of FIG. 23;

FIG. 27 is a block diagram schematic view of a second exemplary embodiment of a fuel system that may incorporate one or more of the previously disclosed embodiments and that is depicted in an engine on mode;

FIG. 28 illustrates the fuel system of FIG. 27 depicted in an engine shutdown mode;

FIG. 29 illustrates the fuel system of FIG. 27 depicted in an engine off mode;

FIG. 30 illustrates the fuel system of FIG. 27 depicted in an engine startup mode;

FIG. 31 is a pictorial schematic view of a third exemplary fuel system of FIG. 1 including an exemplary embodiment of a carburetor, a four-way fuel fitting, and a pneumatic fuel pump adapted for use with an engine of the lawn mower of FIG. 1;

FIG. 32 is a cross-sectional view of the pneumatic fuel pump of the system of FIG. 31;

FIG. 33 is a cross-sectional view of the carburetor of the system of FIG. 31;

FIG. 34 is a cross-sectional view of the four-way fuel fitting of the system of FIG. 31;

FIG. 35 is a block diagram schematic view of a fourth exemplary embodiment of an electrically-actuated fuel system; and

FIG. 36 is a pictorial schematic view of several components of the electrically-actuated fuel system of FIG. 35.

### DETAILED DESCRIPTION OF THE PREFERRED EMBODIMENTS

### Overview

In general, and before referring to the drawing figures, a method, a system, and various apparatuses are disclosed herein. The various exemplary embodiments are all adapted for controlling evaporative emissions of volatile fuel from escaping a fuel system for an engine of a lawn and garden product, or any number of recreational, marine, industrial, and/or agricultural products. The embodiments are adapted for use with gravity draining or fuel pump fuel systems for two or four stroke engines, which may be manual start or electric start engines. The exemplary embodiments are structurally different, but include a number of features in common that will be discussed first herein below.

According to the preferred embodiments disclosed herein, a fuel system is provided for containing, routing, and metering fuel, and delivering the metered fuel to a fuel intake of an internal combustion engine, and the fuel system generally includes a fuel tank and a carburetor. The fuel tank receives a quantity of volatile liquid fuel and is provided for containing the fuel therein until the fuel is delivered to the carburetor. In turn, the carburetor receives the fuel from the fuel tank and is particularly adapted for mixing air with the fuel to create an optimal air/fuel mixture for use by an internal combustion engine. The fuel system preferably further includes a valve and/or valve actuation device in fluid communication with the fuel tank and carburetor for permitting flow of fuel through certain fluid paths of the fuel system when the engine is operating, and for preventing flow of fuel through certain fluid paths when the engine is not operating. The fuel system also preferably includes a mechanical accumulator or pump that withdraws fuel from the carburetor substantially during engine shut down and supplies or returns fuel to the carburetor substantially during engine startup. Alternatively, the fuel system may include the carburetor elevated with respect to the fuel tank to enable gravity draining of fuel from the carburetor.

In any case, liquid fuel is stopped from flowing to the carburetor, is drained and/or withdrawn from the carburetor, and is stored in a preferably sealed receptacle such as the fuel tank and/or a fuel reservoir separate from the tank, substantially during engine shut down. Substantially during engine startup, fuel is permitted to flow to the carburetor and the fuel previously drained and/or withdrawn from the carburetor is returned to the carburetor or to the fuel tank from the receptacle.

The fuel system thereby reduces evaporative emissions from a carburetor and eliminates the need to manually drain fuel from a carburetor prior to transport of the engine-operated apparatus because the carburetor is automatically drained at each engine shut down. Accordingly, the fuel system will be particularly useful on certain engine-powered apparatus such as marine outboard motors because it is common to tilt such outboard motors up and out of the water when not being used and, thus, liquid fuel can leak therefrom. With the present fuel system, however, fuel is prevented from spilling out of the carburetor and into the water or into a boat to which the outboard motor is attached. The present fuel system is also particularly useful with landscaping apparatus such as walk behind lawnmowers because such equipment is typically tilted on its side for maintenance. Using the present fuel system, fuel will no longer spill from the tilted equipment. Therefore, the present fuel system reduces or prevents fuel spills and, thus, fuel emissions from equipment that may be tilted for one reason or another.

The exemplary methods and systems include conventional elements in the art but also may include particularly preferred aspects. In a first preferred example, the fuel tank is of substantially conventional construction, having sidewalls, a bottom wall terminating the sidewalls, a fuel filter disposed in a depressed portion of the bottom wall, and an oppositely disposed top wall terminating the sidewalls and including a fuel cap mounted thereto. Preferably, however, the fuel tank includes a pressure relief valve integrated into a fuel cap or vapor vent outlet fitting that may be mounted to the top of the fuel tank. In a second preferred example, the carburetor is preferably of substantially conventional construction except for a presently preferred fuel bowl design. The carburetor includes a body having a mixing passage for mixing air and fuel therein, a choke valve rotatably disposed in the mixing passage, a throttle valve rotatably disposed in the mixing passage downstream of the choke valve, the preferred fuel bowl carried by the body for receiving liquid fuel from the fuel tank and containing the fuel in a fuel chamber defined therebetween, and a fuel nozzle in fluid communication between the mixing passage and the fuel bowl. The preferred fuel bowl includes an open end, a wall portion extending from the open end, and a closed end that terminates the wall portion and that includes a low-lying collection area and a fuel drain outlet to enable substantially complete drainage of fuel out of the fuel bowl.

### Exemplary Embodiments

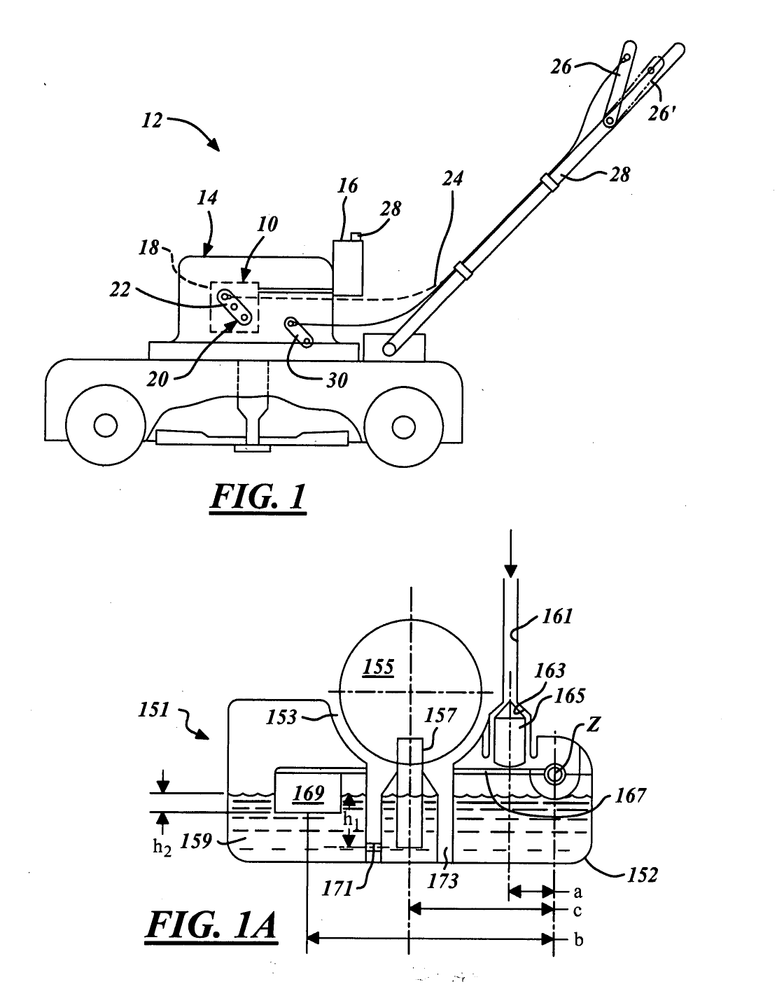

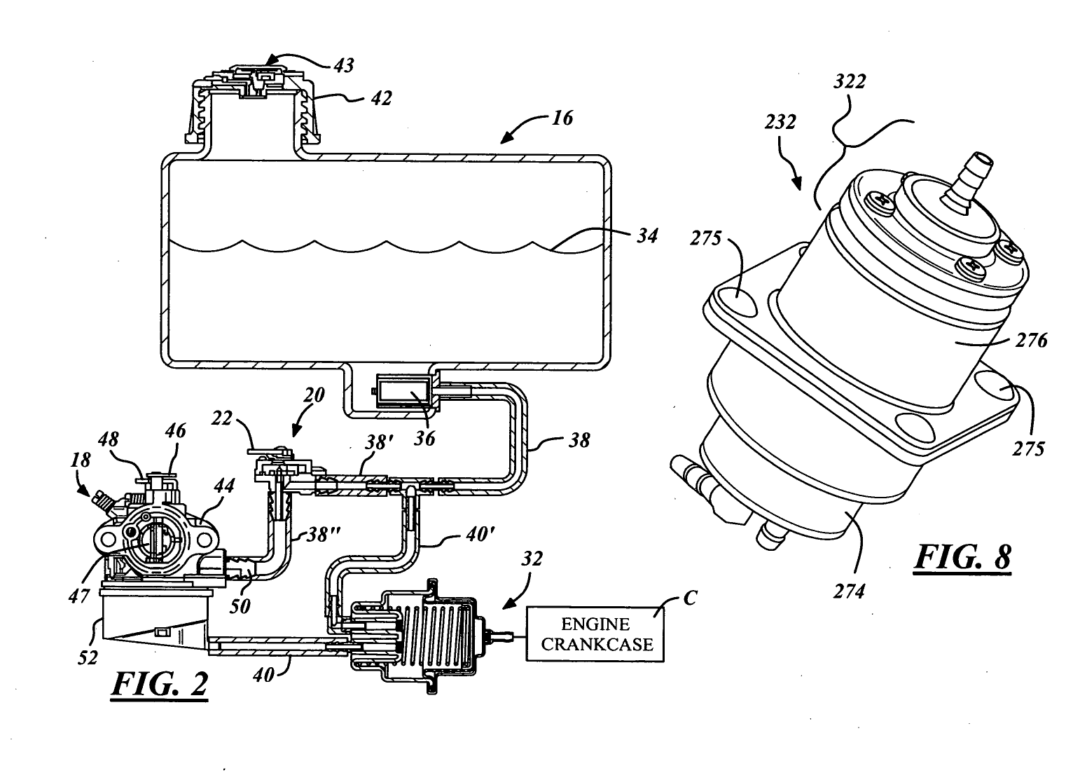

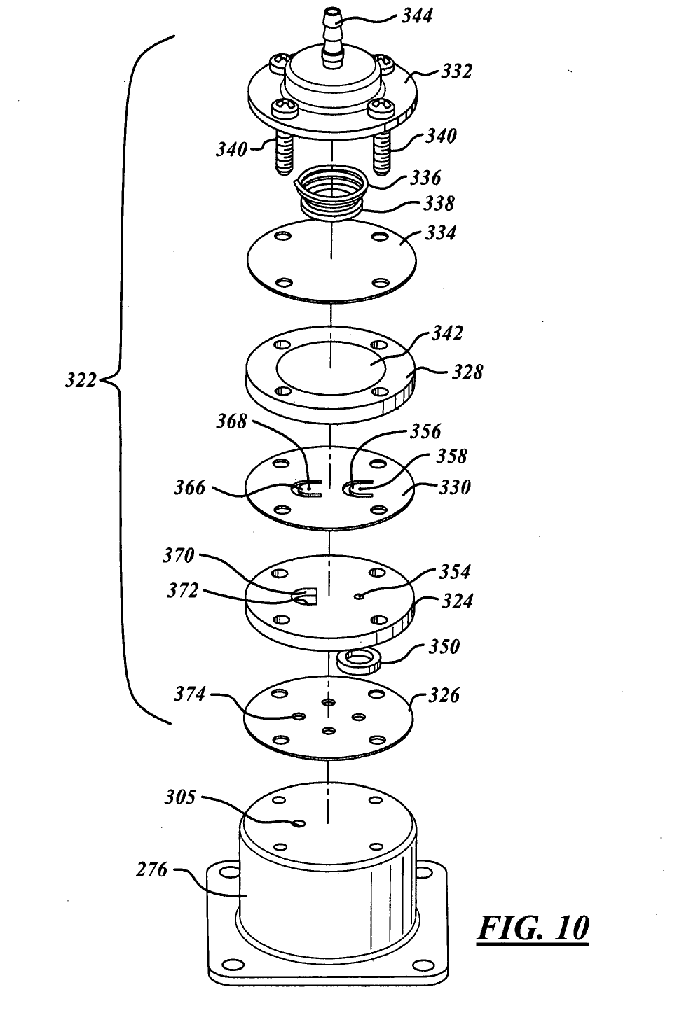

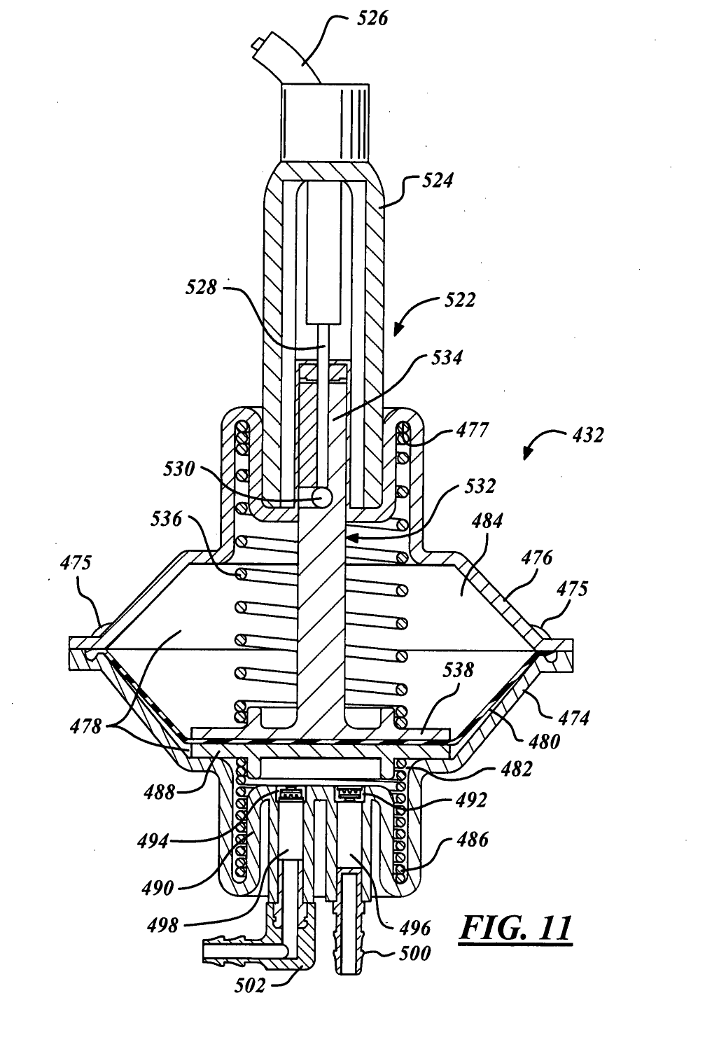

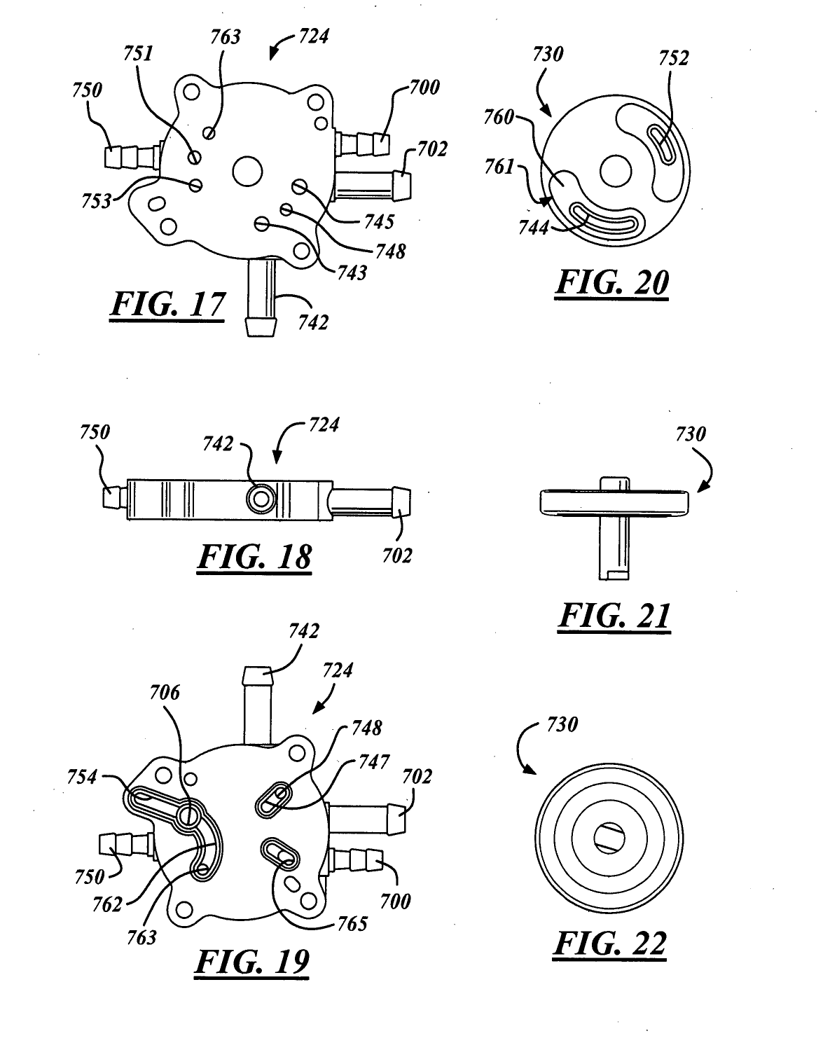

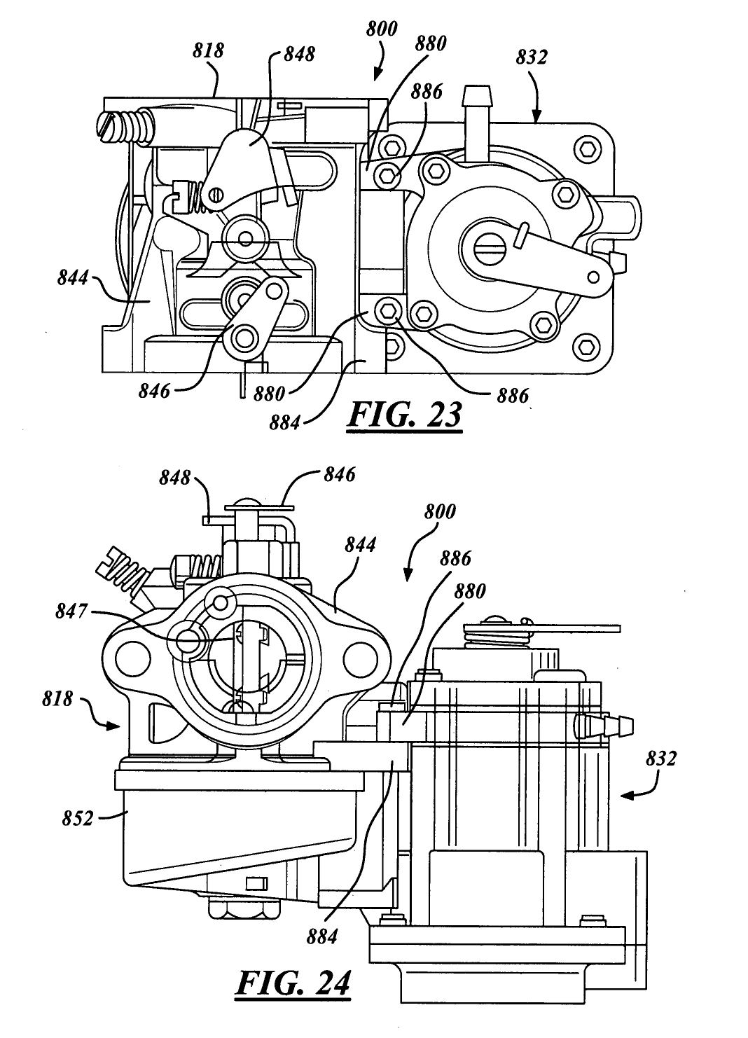

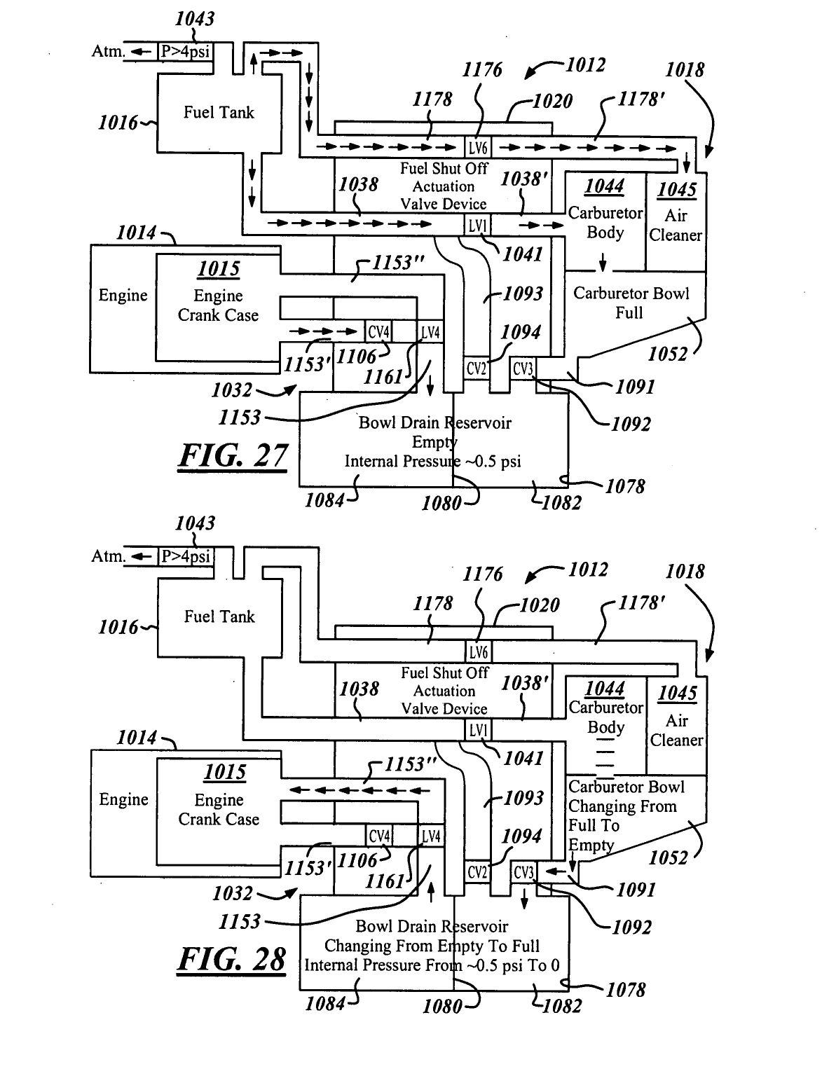

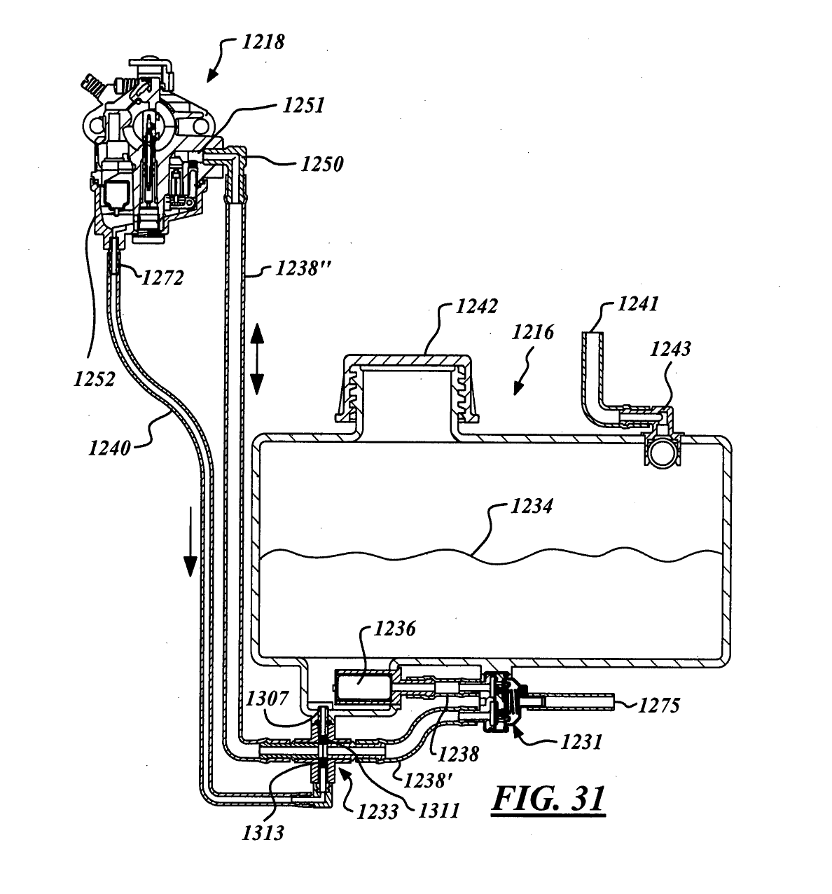

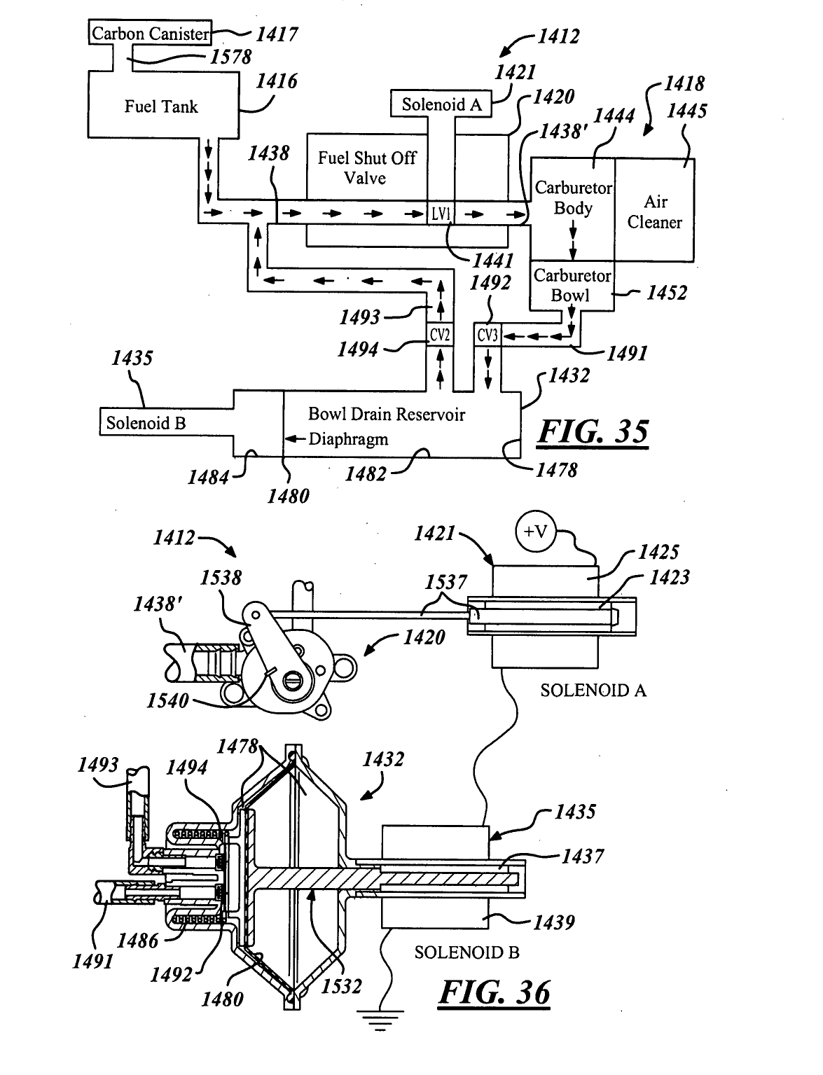

Referring now in detail to the drawing figures, an exemplary embodiment of a fuel system is shown in FIGS. 1 and 2. Next, an exemplary embodiment of a preferred carburetor is depicted in FIGS. 2 through 4. Subsequently, an exemplary embodiment of a mechanical pump is illustrated in FIGS. 5 through 7. Then, a second exemplary embodiment of a mechanical pump is portrayed in FIGS. 8 through 10. A third exemplary embodiment of a mechanical pump is shown in FIG. 11. A fourth exemplary embodiment of a mechanical pump is represented in FIGS. 12 through 22. An exemplary embodiment of a combined carburetor and mechanical pump is depicted in FIGS. 23 through 26. An exemplary embodiment of a generic fuel system is illustrated in block diagrams of FIGS. 27 through 30. An exemplary embodiment of a gravity draining fuel system and components are illustrated in FIGS. 31 through 34. Finally, an exemplary embodiment of an electrically-actuated fuel system and components are illustrated in FIGS. 35 and 36.

### Exemplary Embodiment of a Fuel System

FIG. 1 illustrates evaporative emission control apparatus 10 that is adapted for any type of useful apparatus such as a push or walk-behind lawn mower 12 having a combustion engine 14. A fuel tank 16 contains fuel, which flows to a carburetor 18 during engine startup and/or when the engine 14 is running, but is stopped from flowing during engine shutdown and/or when the engine 14 is not running. The fuel tank 16, carburetor 18, and fuel passages therebetween at least partially define a fuel system.

As used herein, the term “fuel” encompasses liquid fuel, fuel vapor, and any liquid-vapor phase combination thereof. Also, the term “shutdown” is synonymous with cut-off, shut off, deactivated, turned off, killed, to disable, switched off, inoperative, and the like. Those of ordinary skill in the art will recognize that shutdown means the cessation of engine operation such that a crankshaft of the engine slows down and eventually stops due to a lack of fuel and/or ignition supply to the engine. Moreover, the phrase “startup” is synonymous with activated, turned on, to enable, switched on, operative, and the like. Those of ordinary skill in the art will recognize that startup means the beginning of engine operation such that a crankshaft of the engine is set in motion and fuel and spark are supplied to a combustion chamber of the engine. Also, the term “operating” is synonymous with running and basically means that the engine is doing work from input of fuel and ignition of that fuel.

Preferably, manual means are provided for opening one or more fuel passages of the fuel system to permit fuel flow—such as a mechanical, multi-action valve, or valve actuation device 20, of the emission control apparatus 10. The valve actuation device 20 may be actuated to permit flow of fuel when the engine 14 is operating. The valve actuation device 20 may be a stand alone sub-assembly or may be carried by the carburetor 18, and may be manually actuated to an engine-on or valve open position.

As defined herein, the term “valve” means any flow-control apparatus, or one or more features of an apparatus, that is used in regulating flow of fluids in one or more passages. As also defined herein, “valve actuation device” encompasses a device that may include valves, or valve features or elements, integrated therein or in a component thereof, or that may include valve actuating members or portions, which actuate a separate valve that is not integral to the device itself. In other words, the present invention contemplates that the different valve constructions and arrangements, and the fluid conduits of the various embodiments may be substituted for one another or combined in any desired manner.

In contrast with the manual means, automatic means are preferably provided for stopping one or more fuel passages of the fuel system to stop fuel flow. In other words, the valve actuation device 20 is preferably automatically actuated to an engine-off or valve closed position to stop flow of fuel. The valve actuation device 20 may include, or actuate, only one valve, but preferably includes and/or actuates at least two valves substantially simultaneously or with some predetermined delay therebetween, if desired.

Still referring to FIG. 1, the valve actuation device 20 is actuated by a lever 22 that is preferably controlled via a push-pull cable 24, such as a Bowden cable, which is connected to a safety lever or bail 26 that is pivotably attached to a handle 28 of the lawn mower 12. The push-pull cable 24 may be spliced, or may include a plurality of individual cables, in order to additionally engage a pivoting engine ignition shut-off arm or switch 30 and/or other valves or devices. In other words, the emission control apparatus 10 may be actuated substantially simultaneously with an engine ignition control apparatus of the lawn mower 12, wherein a user may release the spring-biased safety lever 26 to also open an ignition circuit to shut off electrical power to a spark plug of the engine 14. Likewise, the emission control apparatus 10 may also be actuated substantially simultaneously with a blade brake, which apparatus is well known to those of ordinary skill in the art. The safety lever 26 thereby pivots from a run or advanced position as shown in phantom lines at 26′ to its biased shut-off position as shown in solid lines at 26. The safety lever 26 is preferably spring-loaded, or spring-biased, so that the user must actively and continuously hold the safety lever 26 in the run position 26′ when operating the lawnmower, or the engine 14 will cease to operate.

Referring now to FIG. 2, the fuel system includes the fuel tank 16, the carburetor 18, the valve actuation device 20 in fluid communication therebetween, and a mechanically actuated accumulator or pump, or mechanical pump 32, in fluid communication between the carburetor 18 and the fuel tank 16. When the engine is operating, liquid fuel 34 flows from the fuel tank 16 through a fuel filter 36, fuel lines or fluid paths 38, 38′, 38″, and the valve actuation device 20, into the carburetor 18. In general, however, the valve actuation device 20 is in a normally closed position to stop flow of liquid fuel through the fuel lines 38′, 38″ from the tank 16 to the carburetor 18. The valve actuation device 20 is adapted to permit flow of liquid fuel into the carburetor 18 when the internal combustion engine is operable, such as when a user holds the safety lever 26 in the run position 26′. The valve actuation device 20 is adapted to prevent flow of liquid fuel into the carburetor 18 during engine shutdown and when the engine is not operating, thereby reducing escape of evaporative emissions of volatile fuel from the fuel system.

As defined herein the terminology “fluid path” or “fuel path” means any route, conduit, or the like for communicating or conveying fluid therethrough. The term “conduit” is likewise broadly defined herein to include integral passages cast, machined, or otherwise formed in the carburetor or individual fuel lines, hoses, or the like, for conveying fluid either liquid or vaporous. In other words, the fuel conduits described herein may take various forms and may be considered sub-components or sub-features of the carburetor or fuel tank or may be considered individual components.

The pump 32 is in fluid communication with the carburetor 18 via fuel lines 40, 40′ and, as will be described in detail below, is adapted to withdraw or pump fuel out of the carburetor 18 and into a receptacle, substantially during engine shutdown, for example, as a result of a user releasing the safety lever 26 from its engine on position 26′ to its biased off position 26. Preferably, the receptacle is sealed and is a reservoir defined within the pump 32 itself, but the receptacle may be separate from the pump and may also be the fuel tank 16 itself or some other separate receptacle. As also will be described in detail below, the pump 32 is adapted to pump fuel out of its reservoir and to another receptacle such as the fuel tank 16 or back to the carburetor 18 substantially during engine startup, for example, as a result of a user gripping the safety lever 26 to its engine on position 26 and mechanically or electrically activating the ignition of the engine.

Those of ordinary skill in the art will recognize that the phrase “substantially during” encompasses a time period not only during the referred to event, but also suitable periods before and after the event. For example, the pump 32 may begin to pump fuel out of the carburetor 18 for a few seconds before the engine starts to shut down and may continue to pump fuel for a few seconds after the engine has shut down. In another example, the pump 32 may begin to pump fuel out of the reservoir for a few seconds before ignition of the engine and may continue to pump fuel for a few seconds after the engine has been started and is running.

The tank 16 is provided for containing liquid and vapor fuel and may be sealed with a cap or closure 42, wherein the tank 16 and closure 42 may be composed of any suitable materials including a multi-layer plastic composition having a vapor barrier layer. As one example without limitation, the tank 16 and closure 42 may be composed of an ethylene-vinyl-alcohol barrier layer that is sandwiched between high density polyethylene structural layers. Similarly, the fuel lines 38, 40 may be composed of multiple layers and by way of example, may be three layer non-conductive fuel lines such as Permblok® 330 hoses commercially available from TI Automotive of Warren, Mich. The closure 42 may be a ventless closure, or a vented closure as shown such as that disclosed in U.S. patent application Ser. No. 10/955,133, filed on Sep. 30, 2004, and entitled EVAPORATIVE EMISSIONS CONTROLS IN A FUEL SYSTEM, which is assigned to the assignee hereof and is hereby incorporated herein by reference. The fuel filter 36 is optional and is provided for filtering liquid fuel exiting the fuel tank 16, and may be any one of a multitude of conventional fuel pick-up filters, which are well known in the art.

The fuel system preferably incorporates the mechanical shutoff valve 20 that is in communication with the fuel lines 38 and may be similar to that which is described in U.S. patent application Ser. No. 10/955,795, filed Sep. 30, 2004 and entitled EVAPORATIVE EMISSIONS CONTROLS, which is assigned to the assignee hereof and is hereby incorporated herein by reference. The shutoff valve includes the lever 22, which is controlled via the push-pull cable to normally stop flow of fuel through the fuel lines 38 from the tank 16 to the carburetor 18, unless the shutoff valve is deactivated or opened by a user moving the safety lever 26 to the run position 26′.

### Exemplary Embodiment of a Carburetor

Still referring to FIG. 2, and aside from the novel features described herein, the carburetor 18 may otherwise be constructed consistent with a low evaporative emission float-bowl carburetor, such as those exemplified by U.S. Pat. No. 6,561,495 or U.S. Pat. No. 6,640,770, both of which are assigned to the assignee hereof and incorporated herein by reference in their entireties for exemplary purposes. For example, the carburetor 18 includes a carburetor body 44 with a passage 45 for mixing air with fuel for delivery to an intake of an engine. The body 44 includes a choke lever 46 for operating a choke valve 47, a throttle lever 48 for operating a throttle valve 49, and a fuel inlet fitting 50 that connects to one of the liquid fuel lines 38″. The carburetor 18 also includes a preferred float bowl or fuel bowl 52 carried by the body 44. The fuel bowl 52 may be of preferred design and construction as described below after the following background discussion.

FIG. 1A illustrates a cross section of a portion of an exemplary carburetor 151 including a float valve arrangement. The carburetor 151 includes a float bowl 152 mounted to a body 153 to define a fuel chamber. The carburetor 151 includes a fuel and air mixing passage 155 extending therethrough and a fuel nozzle 157 in communication with the mixing passage 155 to deliver fuel 159 from the fuel chamber or bowl 152 to the mixing passage 155. A fuel inlet passage 161 extends through a portion of the body 153 and terminates in a valve seat 163. An inlet needle valve or float valve 165 is adapted to valve the fuel inlet passage 161 by sealing against the valve seat 163 when a float arm 167 is raised by buoyancy of a float 169 in the liquid fuel in the fuel chamber and by separating from the valve seat 163 when the float arm 167 lowers. A restricted orifice or fuel nozzle jet 171 is provided through a fuel nozzle post 173 to meter flow of the liquid fuel 159 from the fuel chamber into a fuel well defined at least partially by the nozzle 157. The float valve 165 seats and unseats to block and permit flow of fuel through the inlet passage 161 into the fuel chamber in response to the changing fuel level via movement of the float arm 167 about a pivot axis Z.

Typically, the quantity of liquid fuel in a fuel bowl 152 is much greater than is needed for proper engine operation. Thus, one way to reduce evaporative emissions from a carburetor fuel bowl is to reduce the quantity of liquid fuel in the bowl to substantially the minimum quantity of liquid fuel needed for proper engine operation under all operating conditions likely to be encountered by the engine application. According to the following analysis, fuel volume in the carburetor 151 may be minimized.

In addition to a weight Wᵥ of the float valve 165, an incoming fuel pressure P acts on an exposed area Aᵢ of the float valve 165 that corresponds to an exposed diameter Dᵢ of the float valve 165, to unseat the float valve 165 from the valve seat 163. In contrast, the float valve 165 tends to be seated against the valve seat 163 by a buoyancy force F_{f} of the float 169 minus the weight W_{f} of the float 169. The buoyancy force F_{f} is the volume V_{f} of fuel displaced by the float 169 multiplied by the density of the fuel 159. The volume V_{f} of fuel displaced is the horizontal surface area A_{f} of the float 169 that is exposed to the fuel 159 multiplied by a vertical distance h₂ between the bottom of the float 169 and the surface of the fuel 159. It is desirable to maintain a vertical distance h₁ between the jet 171 and the surface of the fuel 159 as constant as possible.

A lateral distance ‘a’ is depicted between the float pivot axis Z and an operating or vertical axis of the float valve 165 and inlet passage 161. A lateral distance ‘c’ is shown between the float pivot axis Z and the lateral centerline of the weight distribution of the float 169 and float arm 167. The weight of the float 169 and float arm 167 is represented by Wₗ, and those of ordinary skill in the art will recognize that the float 169 and the float arm 167 may be integrated into one component or float. Moreover, a lateral distance ‘b’ is illustrated between the float pivot axis Z and the vertical axis of the fuel buoyancy force F_{f}.

Summing torques about the float pivot axis Z yields the following equation: a(PAᵢ+Wᵥ)+cWₗ=bF_{f}. It may be assumed that Wᵥ and Wₗ are negligible relative to the other forces involved. Assuming the density of the fuel is 0.73 specific gravity, the float buoyancy force F_{f} may be substituted for 0.73V_{f}. The exposed float valve area Aᵢ may be expressed as πDᵢ²/4. These expressions may be substituted to yield the following modified equation: a(0.785 PDᵢ²)=b(0.73 V_{f}). Solving for V_{f} yields the following equation: V_{f}=1.076a(PDᵢ²)/b. Substituting (A_{f}×h₂) for V_{f} yields A_{f}×h₂=1.076a(PDi²)/b. Therefore, h₂=1.076aPDᵢ²/(bA_{f}).

From the above, it can be seen that h₂ is proportional to P for any given design, assuming A_{f} is constant. In other words, if P doubles, then h₂ doubles. To keep the absolute change of h₂, and of h₁, to a minimum, h₂ should be as small as possible so that multiples of h₂ are also relatively minimal. Therefore, a and Dᵢ should be as small as practical and A_{f} and b should be as large as practical.

Therefore, a method of reducing evaporative emissions from a carburetor includes minimizing one or the other or preferably both of the size of the inlet fuel passage 161 or the lateral distance ‘a’ between the float pivot axis Z and at least one of the vertical axis of the inlet fuel passage 161 or the inlet valve 165, while simultaneously maximizing one or the other or preferably both of the fuel contact surface area A_{f} of the float 169 or the lateral distance ‘b’ between the float pivot axis Z and the vertical axis of the fuel buoyancy force, wherein the volume of fuel within the fuel bowl is substantially minimized. For example, the volume of fuel may be minimized from a typical value of about 25 to 35 cc for a small engine carburetor to a value of about 12 to 16 cc. In other words, the volume of fuel may be reduced by as much as 50% or more. The term minimizing includes substantially minimizing and does not require absolutely minimizing, nor does it require a reduction of 50% or more. The term maximizing includes substantially maximizing and does not require absolutely maximizing something.

Moreover, the fuel volume on the side of the nozzle 157 opposite the float 169 (i.e. in FIG. 1A the pivot axis side of the nozzle 157) does not contribute to the buoyancy of the float 169. Therefore, it is preferred to keep that fuel volume to a minimum. This may be accomplished by modifying the fuel bowl 152 to yield a minimum volume of fuel on the pivot axis side of the nozzle 157 in favor of relatively more fuel volume on the float side of the nozzle 157. In other words, the fuel bowl 152 may be modified to include an angled inside bottom surface that slopes downwardly and laterally away from the pivot axis Z of the float arm 167.

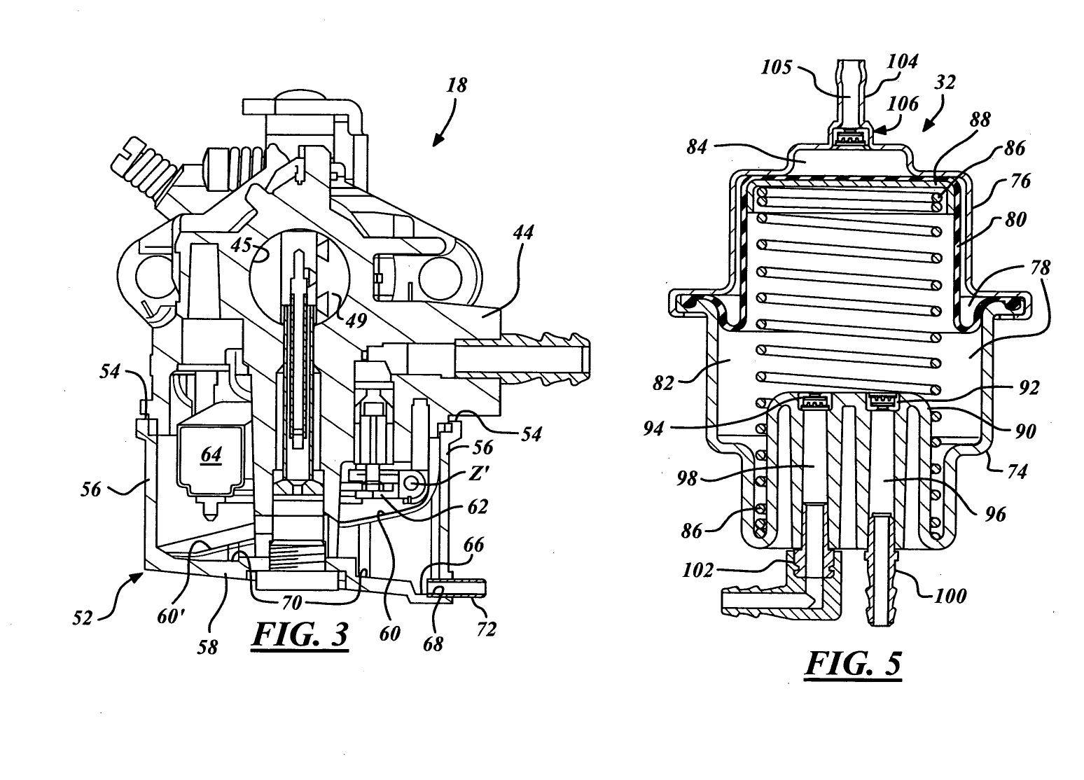

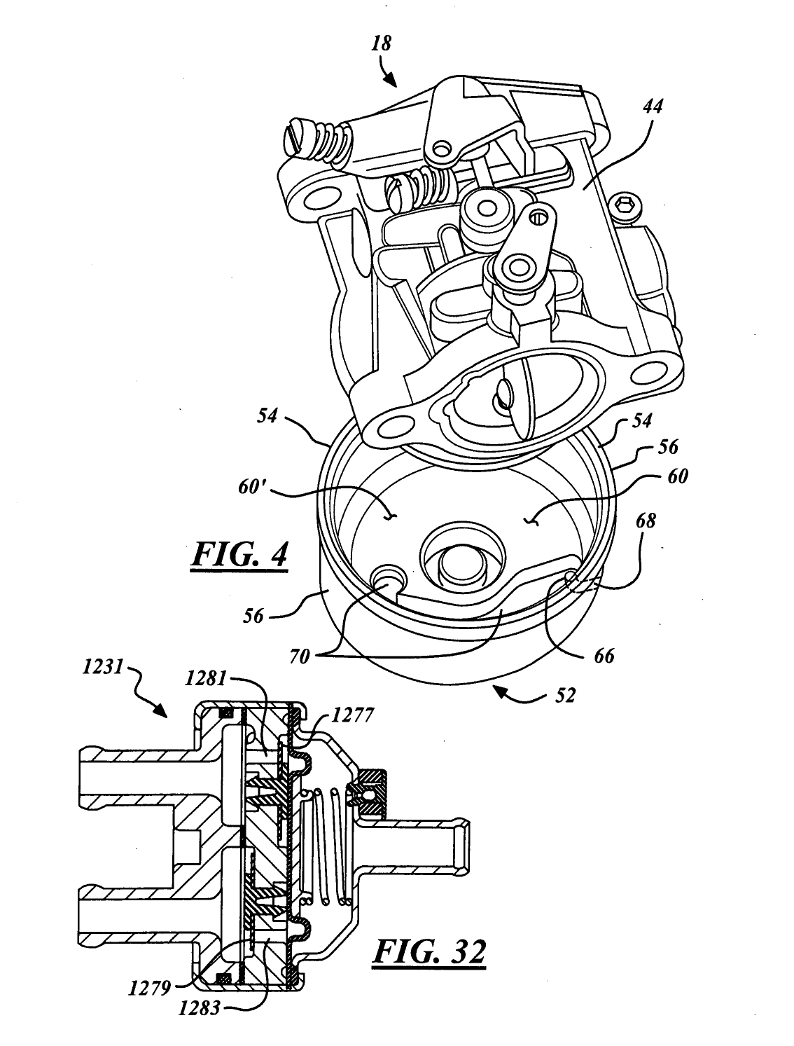

Such a fuel bowl modification is depicted in FIGS. 2 through 4, which show the preferred carburetor 18 with the angled fuel bowl 52. As best shown in FIGS. 3 and 4, the fuel bowl 52 includes an open end 54, a wall 56 extending downward from the open end 54, and a closed end 58 terminating the wall 56. The closed end 58 includes an inside bottom surface 60, 60′ that is sloped at the same or a similar angle with respect to the angle of a float arm 62 when the float arm 62 is in the full open position. The fuel chamber of the carburetor 18 is basically defined between the inside bottom surface 60, 60′ of the fuel bowl 52 and the body 44. To accommodate as large a distance as possible between a float pivot axis Z′ and a lateral centerline of a float 64, it is desirable to keep the left side of the float 64 as close as practicable to the inside surfaces of the wall 56 of the float bowl 52, such as about 0.050″, taking manufacturing tolerances into consideration. While this bowl design minimizes fuel volume to reduce evaporative emissions, it is also desirable to further enable substantially complete drainage of liquid fuel from the fuel bowl 52 of the carburetor 18. As used herein, the phrase “substantially complete” encompasses more than 50% drainage and preferably encompasses greater than 75% drainage.

Accordingly, the fuel bowl 52 is provided with a low-lying collection area 66 and a fuel drain outlet 68 disposed substantially at the low-lying collection area 66. In other words, the fuel drain outlet 68 is positioned in such proximity to the low-lying collection area 66 so as to enable substantially complete drainage of liquid fuel out of the fuel bowl 52 through the fuel drain outlet 68. As used herein, the phrase “low-lying collection area” means a portion of the fuel bowl that is relatively low compared to the rest of the fuel bowl (when in its normal attitude or orientation when in use in a given engine application) to enable fuel to accumulate there under the force of gravity. As best shown in FIG. 4, the low-lying collection area 66 is in fluid communication with the fuel chamber via a gutter or channel 70 provided in the closed end 58 of the fuel bowl 52. The channel 70 slopes away from the inside bottom surface 60′ toward the low-lying collection area 66 to enable liquid fuel to exit the fuel bowl 52 through a fitting 72 extending through the drain outlet 68.

Accordingly, the method of reducing evaporative emissions from the carburetor is further enhanced by angling an inside bottom surface of a fuel bowl, preferably in a direction laterally and downwardly away from the float pivot axis, and more preferably, toward a low-lying collection area of the fuel bowl. But, to more fully ensure substantially complete drainage of liquid fuel from a carburetor, it is further desirable to provide means for removing the liquid fuel from a fuel bowl of the carburetor.

### First Exemplary Embodiment of a Mechanical Pump

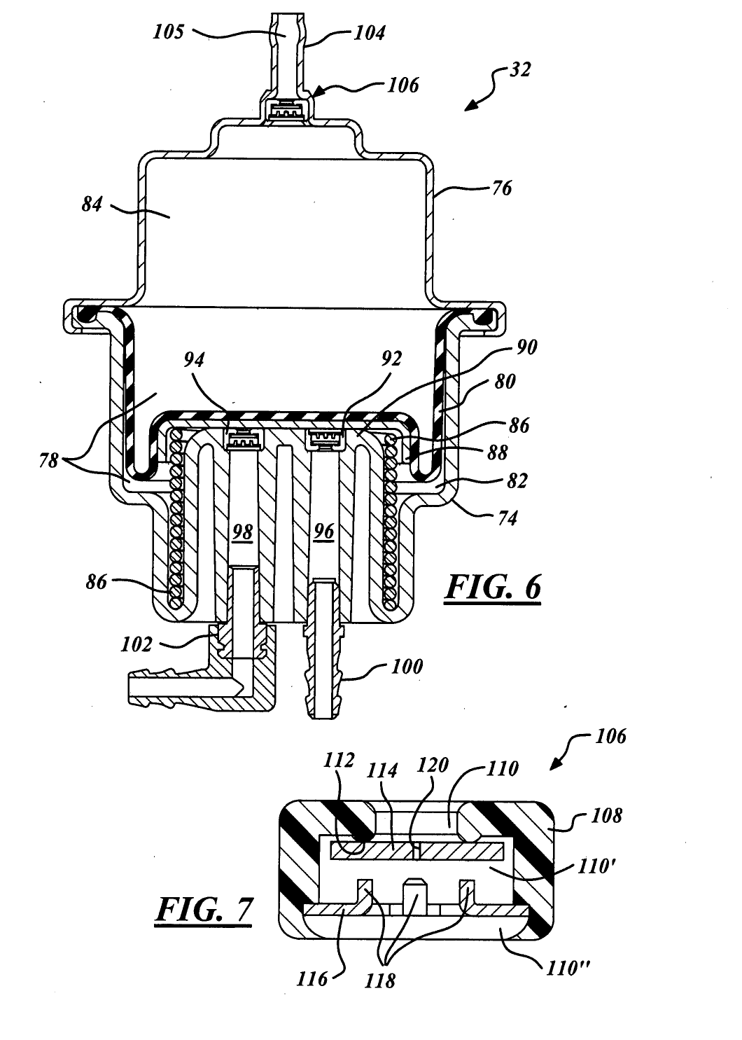

The fuel is removed from the carburetor fuel chamber or bowl 52 preferably using a fuel transfer and storage unit, such as the mechanical accumulator or pump 32 of FIG. 2. It is contemplated that any suitable type of pump could be used including an electrically-actuated pump (“electric pump”), pneumatic mechanical pumps, plunger style mechanical pumps, and the like. As also shown in FIGS. 5 and 6, the pump 32 includes a housing 74 and a cover 76 attached to the housing 74, such as by a circumferential crimp joint as shown, to define an interior 78. The housing 74 and cover 76 are preferably stamped or machined from metal, molded from a polymeric material, or the like.

A diaphragm 80 is disposed within the interior 78 and is sealingly engaged between the cover 76 and housing 74 by the crimp joint to divide the interior 78 into a fuel reservoir 82 on a reservoir side of the diaphragm 80 for carburetor bowl drainage, and an actuation chamber 84 on an actuation side of the diaphragm 80 used primarily for advancing the diaphragm 80. As used herein, the term “reservoir” encompasses any suitable receptacle for storing fuel drawn from the carburetor bowl 52 to be recycled thereto or to the fuel tank. The diaphragm 80 may be composed of any suitable fuel resistant elastomeric material, or other material suitable for use in a fuel system.

The phrase “polymeric material” generally includes relatively high-molecular-weight materials of either synthetic or natural origin and may include thermosets and thermoplastics. For use in fuel systems, the polymeric material preferably exhibits suitable non-permeation and resistance to hydrocarbon fuels such as gasoline, gasohol, alcohol, and diesel. The term elastomeric also encompasses any of various elastic substances resembling rubber, such as a fluorocarbon like Viton®, a nitrile such as acrylonitrile-butadiene, or the like. In general, the materials used for the components may be selected based on their dimensional stability, non-permeation, and resistance to swelling and degradation in warm and cold flexible hydrocarbon fuel environments.

A coiled metal compression spring 86 is disposed within the fuel reservoir 82 to yieldably bias the diaphragm 80 against an inside surface of the cover 76. A protective cup or plate 88 is disposed between the diaphragm 80 and the adjacent end of the spring 86. The other end of the spring 86 circumscribes a central boss 90 that includes fuel inlet and outlet check valves 92, 94 disposed in fluid communication with the fuel reservoir 82 and inlets and outlets 96, 98 of the pump 32. The inlets and outlets 96, 98 include respective inlet and outlet fittings 100, 102 inserted therein. At an opposite end of the pump 32, the cover 76 includes an integral fitting 104 defining a pressure pulse port 105 with a pneumatic check valve 106 disposed therein in communication with the actuation chamber 84.

The pneumatic check valve 106 is best depicted in FIG. 7 and includes a generally annular housing 108 defining a through passage 110 including first and second counterbores 110′, 110″. The check valve 106 is preferably composed of metal, polymeric, and/or elastomeric components. An inlet end includes an annular valve seat 112 for engaging a disc 114 in its closed position seated against the valve seat 112. At an outlet end of the check valve 106, an open valve retainer 116 is inserted into the second counterbore 110″ and includes projections 118 for supporting the disc 114 in its open position bearing on the projections 118. The housing 108 is crimped over to retain the valve retainer 116. As shown, the check valve 106 is closed such that fluid cannot easily pass therethrough from the outlet end to the inlet end, unless the fluid is under such pressure as to flow through a pinhole 120 in the disc 114. When the check valve 106 is open, the disc 114 unseats and locates against the projections 118 of the retainer 116 such that fluid enters the through passage 110 at the inlet end and easily flows around the circumferential periphery of the disc 114, through the open retainer 116, and out the outlet end of the valve 106. The fuel check valves 92, 94 are substantially similar in construction and operation, except that there are no pinholes provided in discs thereof.

During engine operation, the pump 32 is powered by positive pressure pulses to move the diaphragm 80 from its retracted position shown in FIG. 5 to its advanced position shown in FIG. 6. In its retracted position of FIG. 5, liquid fuel that was previously received from the carburetor bowl 52 is temporarily stored in the fuel reservoir 82. Many engines, when operating, generate a positive pressure pulse in their crankcase that may be used to power the pump 32. In one example shown in FIG. 2, an engine crankcase C is in fluidic communication with the port 105 of the pump 32. Accordingly, when the engine is operating, positive pressure pulses of air pass through the check valve 106 and into the actuation chamber 84 of the pump 32. As more and more air enters the actuation chamber 84 through the check valve 106, air pressure increases in the actuation chamber 84 and thereby displaces the diaphragm 80 in an advancing direction against the force of the spring 86. As shown in FIG. 6, the liquid fuel has substantially been forced out of the fuel reservoir 82 through the outlet check valve 94 and outlet 98 by displacement of the diaphragm 80 from its retracted position against the inside surface of the cover 76 to its fully advanced position against the boss 90 of the housing 74. Referring to FIG. 2, the fuel is forced out of the pump 32 through the fuel line 40′ and back toward the fuel tank through lines 40′ and 38 and/or toward the carburetor 18 through the fuel lines 38′, 38″ as the shutoff valve 20 is open during engine operation. Although some fluid from the actuation chamber 84 may pass through the pinhole 120 of the check valve disc 114 during engine operation (when a negative pressure pulse is produced in the engine crankcase), the pinhole 120 is preferably sized so that the magnitude and frequency of the positive pressure pulses are sufficient to maintain the diaphragm 80 in its advanced state against the housing 74 despite any pressure lost through the pinhole 120.

The diaphragm 80 maintains its advanced position until the engine stops and, therefore, the pressure pulses from the crankcase cease. When the engine stops, the pressure in the actuation chamber 84 is relieved or vented through the pinhole 120. The force of the spring 86 is thus able to move the diaphragm 80 toward the cover 76 thereby increasing the volume of the fuel reservoir 82 and simultaneously decreasing the volume of the actuation chamber 84 wherein fluid is slowly vented through the pinhole 120 in the check valve disc 114. Referring to FIGS. 3 and 5, as the volume of the fuel reservoir 82 increases, liquid fuel is drawn out of the carburetor bowl 52 through the drain outlet 68, fitting 72, and the fuel line 40 and into the fuel reservoir 82 through the inlet 96 and inlet check valve 92. The maximum volume of the fuel reservoir 82 of the pump 32 is preferably greater than or at least equal to the volume of fuel held in the fuel bowl 52 of the carburetor 18 during normal engine operation.

Referring also to FIG. 2, substantially during engine shutdown, the fuel shutoff valve 20 closes to stop fuel flow to the carburetor 18. Accordingly, little to no fuel is left in the fuel bowl 52 of the carburetor 18, thereby greatly reducing evaporation and escape of fuel vapor from the carburetor 18 into the atmosphere. The liquid fuel is sealed within the fuel tank 16, fuel lines 38, 38′, 38″, 40′, and the pump 32. Fuel in the fuel reservoir 82 of the pump 32 may tend to permeate through the diaphragm 80. Therefore, the spring plate 88 is provided to create an annular seal between the plate 88 and the cover 76. Fuel cannot pass through the plate 88 to reach the actuation chamber 84 and any fuel permeating the sides of the diaphragm 80 is trapped by the cover 76. When the engine is restarted, such permeated fuel vapors will preferably be returned to the engine crankcase and, vented to the engine air intake.

Some engine-powered apparatuses may not be amenable to use with the previously described pneumatic pump 32. For example, some engines may not generate crankcase pressure pulses of sufficient magnitude to power a pneumatic pump that withdraws fuel from a carburetor and returns it to a fuel tank. Crankcase pressure pulses of a relatively small four stroke engine are typically about 1.0 to 1.5 in Hg, which is equivalent to about 18 to 27 inches of fuel head. Accordingly, if the level of fuel in a fuel tank is greater than 18 to 27 inches above the associated pneumatic pump, then the pneumatic pump will not be able to move liquid fuel back to the tank under power from the crankcase pressure pulses. Moreover, pressure build up within a fuel tank may make it difficult if not impossible to move liquid fuel from the pump to the fuel tank. The force of the spring should be of sufficient magnitude to overcome the internal resistance of the diaphragm and to draw fuel from the fuel bowl. Yet, the net pressure acting on the diaphragm (actuation chamber pressure minus the force generated by the spring) should be greater than the combined pressure within the fuel tank plus the fuel head pressure. Otherwise, the pump outlet check valve 94 remains closed.

### Second Exemplary Embodiment of a Mechanical Pump

FIGS. 8 through 10 illustrate a second exemplary embodiment of a mechanical pump in the form of another pneumatic pump 232, which is designed to operate on negative, or vacuum, pulses from an engine intake manifold, such as for a single or multiple cylinder four-stroke engine. The pneumatic pump 232 is adapted to generate relatively greater pressure than the previously described pneumatic pump 32 to overcome a typical superatmospheric pressure within a fuel tank plus a typical fuel head pressure. This embodiment is similar in many respects to the embodiment of FIGS. 5 through 7 and like numerals between the embodiments may generally designate like or corresponding elements throughout the several views of the drawing figures. Additionally, some of the common subject matter may not be repeated herein below.

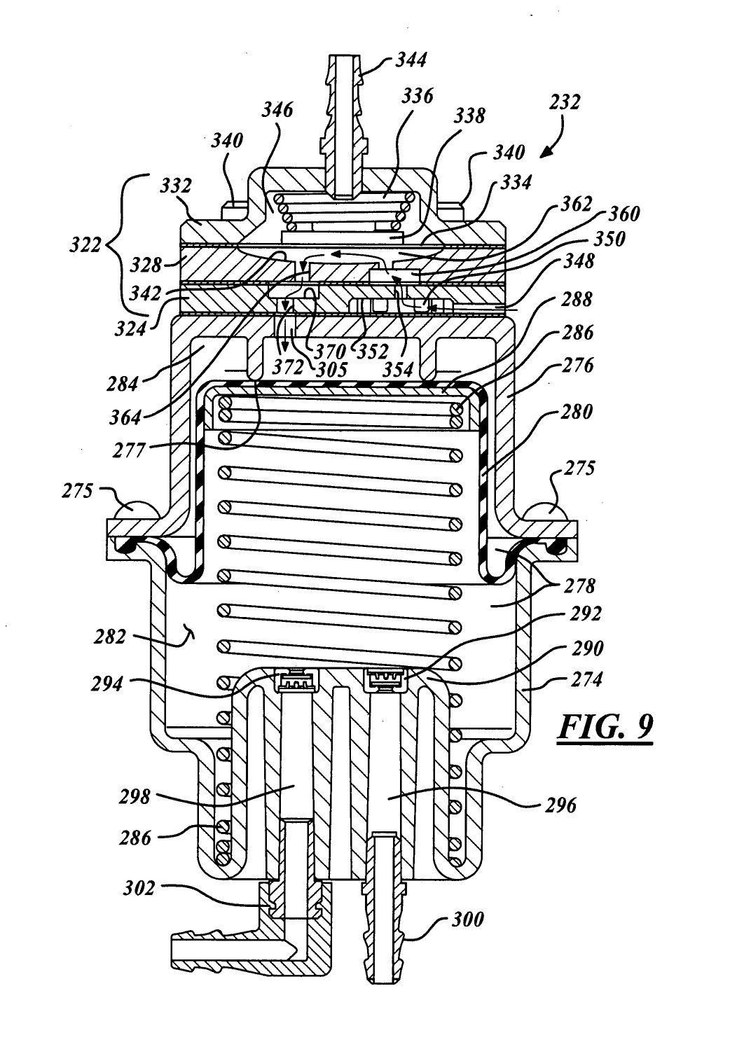

FIGS. 8 and 9 illustrate the pneumatic pump 232, which is adapted to use negative or vacuum pulses received from an engine intake manifold (not shown) to produce positive pressure pulses to actuate the diaphragm 280 of the pump 232. The pump 232 includes a housing 274 and a cover 276 attached to the housing with fasteners such as rivets 275 or the like, to define an interior 278. As shown in FIG. 9, a diaphragm 280 is disposed within the interior 278 and is sealingly engaged between the cover 276 and the housing 274 to divide the interior 278 into a fuel reservoir 282 and an actuation chamber 284. A coiled compression spring 286 is disposed within the fuel reservoir 282 to yieldably bias the diaphragm 280 against an annular projection 277 of the cover 276. A spring plate 288 is received between the diaphragm 280 and the adjacent end of the spring 286. The other end of the spring 286 circumscribes a central boss 290 that includes inlet and outlet check valves 292, 294 disposed in fluid communication with the fuel reservoir 282 and inlets and outlets 296, 298 of the pump 232. The inlets and outlets 296, 298 include respective inlet and outlet fittings 300, 302 inserted therein. At an opposite end of the pump 232, the cover 276 includes a pressure port 305 in communication with the actuation chamber 284 on one side and a vacuum pump 322 on the other.

Referring to FIGS. 9 and 10, the vacuum pump 322 is provided to convert negative, or vacuum, pulses from an engine intake manifold (not shown) into positive pressure pulses to pressurize the actuation chamber 284. The vacuum pump 322 generally includes a valve plate 324 mounted against the cover 276 with a mounting gasket 326 between them, a diaphragm plate 328 mounted against the valve plate 324 with a valve diaphragm 330 between them, and a cover 332 that traps a vacuum diaphragm 334, spring 336, and spring plate 338, and that is mounted against the diaphragm plate 328 and to the cover 276 with bolts 340 extending through apertures in the diaphragms 330, 334, plates 324, 328, and gasket 326.

The vacuum pump 322 operates according to alternating vacuum pulses and a spring force to supply, for example, four to five psig of air pressure depending on the magnitude of the incoming vacuum pulses. The vacuum pump 322 accepts vacuum pulses and incoming atmospheric air, and filters the incoming air and uses the vacuum pulses to move the air into the actuation chamber 284. The compression spring 336 normally biases the spring plate 338 and diaphragm 334 toward a bowl-shaped surface 342 in the diaphragm plate 328. During engine operation, vacuum pulses are received through a fitting 344 in the cover 332 into a vacuum chamber 346 defined between the diaphragm 334 and the cover 332. The vacuum pulses tend to evacuate the vacuum chamber 346 pulling the diaphragm 334 toward the cover 332 against the bias force of the spring 336. Between vacuum pulses, the force of the spring 336 pushes the diaphragm 334 back toward the diaphragm plate 328.

With each vacuum pulse, the valve plate 324 accepts incoming atmospheric air through a groove or channel therein that partially defines an inlet passage 348 between the valve plate 324 and the cover 276. An annular filter 350 is disposed within a pocket 352 of the valve plate 324 to filter the incoming air. The air flows through an aperture 354 in the valve plate 324 and past an inlet valve flap 356 of the valve diaphragm 330 that has a pinhole 358 therethrough. The air then flows through an inlet valve pocket 360 in the diaphragm plate 328 into a pressure chamber 362 defined between the vacuum diaphragm 334 and the bowl-shaped surface of the diaphragm plate 328.

With each spring pulse, the air in the pressure chamber 362 is substantially prevented from flowing out of the pump 322 by the inlet valve flap 356. Instead, the now pressurized air flows out of the pressure chamber 362 through an outlet passage 364 in the diaphragm plate 328 and past an outlet valve flap 366 of the valve diaphragm 330 that has a pinhole 368 therethrough. The pressurized air flows through an outlet valve pocket 370 and an outlet aperture 372 of the valve plate 324 and out of the vacuum pump 322 through an outlet aperture 374 of the mounting gasket 326.

The pneumatic pump 232 is powered by the positive pressure air pulses received from its associated vacuum pump 322 to move the diaphragm 280 from its retracted position shown in FIG. 9 to its advanced position (not shown). In its retracted position of FIG. 9, liquid fuel that was previously received from the carburetor 18 is temporarily stored in the fuel reservoir 282. When the engine is operating, positive pressure pulses of air from the vacuum pump 322 pass into the actuation chamber 284. As air continues to enter the actuation chamber 284, air pressure increases in the actuation chamber 284 and thereby displaces the diaphragm 280 in an advanced direction against the force of the spring 286.

In its fully advanced position, the liquid fuel substantially has been forced out of the fuel reservoir 282 through the outlet check valve 294 and outlet 298 by displacement of the diaphragm 280 from its retracted position against the annular projection 277 of the cover 276 to its fully advanced position against the boss 290 of the housing 274. The fuel is forced out of the pump 232 and into the rest of the fuel system as described previously with respect to the first exemplary embodiment of the pump 32. Although some fluid from the actuation chamber 284 may pass through the pinholes 368, 358 of the valve flaps 366, 356 during engine operation, the pinholes 368, 358 are preferably sized so that the magnitude and frequency of the air pressure pulses are sufficient to maintain the diaphragm 280 in its forward state against the housing 274 despite any pressure lost through the pinholes 368, 358.

The two previously described embodiments provide suitable reservoir and pneumatic pumps for removing fuel from a carburetor with many fuel system and engine configurations. But there may be other fuel system and engine applications that are not suited to such pneumatic pumps. For example, in some applications a fuel tank may be mounted very high relative to a carburetor or the fuel tank may have relatively high internal pressure compared to pressure pulse output of the associated engine. In such applications, pneumatic style pumps may not be as desirable as the alternative described below.

### Third Exemplary Embodiment of a Mechanical Pump

FIG. 11 illustrates a third exemplary embodiment of a mechanical pump in the form of a plunger actuated pump, or plunger pump 432, that is designed to operate based on manually imposed or spring imposed forces to generate relatively greater pressure than the previously described pneumatic pumps 32, 232 and thereby overcome internal fuel tank pressure combined with fuel head pressure. This embodiment is similar in many respects to the embodiments of FIGS. 1 through 10 and like numerals between the embodiments may generally designate like or corresponding elements throughout the several views of the drawing figures. Additionally, some of the common subject matter may not be repeated herein below.

FIG. 11 illustrates the plunger pump 432 in an engine on position. The pump 432 includes a housing 474 and a cover 476 attached to the housing 474 with fasteners such as rivets 475 or the like, to define an interior 478. As shown in FIG. 11, a diaphragm 480 is disposed within the interior 478 between the housing 474 and the cover 476 to divide the interior 478 into a fuel reservoir 482 and an actuation chamber 484. A coiled compression spring 486 is disposed within the fuel reservoir 482 and, via a spring plate 488 at one end, engages the diaphragm 480. At an opposite end of the spring 486, the spring 486 circumscribes a central boss 490 that includes inlet and outlet check valves 492, 494 disposed in fluid communication with the fuel reservoir 482 and inlets and outlets 496, 498 of the pump 432. The inlets and outlets 496, 498 include respective inlet and outlet fittings 500, 502 inserted therein.

The plunger pump 432 includes a plunger apparatus 522 to convert push-pull motion into displacement of the diaphragm 480 to discharge fuel out of the fuel reservoir 482. The plunger apparatus 522 generally includes a connector housing 524 engaged to the cover 476 for holding an actuator such as a push-pull cable assembly including a sheath 526 with a wire 528 slidably mounted therein. The wire 528 terminates in a ball-shaped end 530 that is interengaged to a plunger 532 that includes a stem 534 that is slidably received in the connector housing 524. An advance spring 536 circumscribes the stem 534 of the plunger 532 and is seated within a spring seat 477 of the cover 476. The stem 534 terminates in a spring plate 538 that receives the other end of the spring 536 and is adapted to be positioned against the diaphragm 480.

As shown, the plunger pump 432 is preferably actuated by movement of the push-pull wire 528, which is preferably adapted for operating in accordance with the safety bail 26, which is pivotably attached to the handle 28 of the lawn mower 12 of FIG. 1. Those of ordinary skill in the art will recognize that the wire 528 is preferably attached to the safety bail 26 on a side of the pivot axis of the safety bail 26 opposite of where the push-pull cable for the valve 20 is attached. Alternatively, the wire 528 could be attached to the safety bail 26 via a pivotable reversal link. In any case, when a user grips the safety bail 26 and moves it against the handle 28 in the engine running position 26′, the push pull wire 528 is adapted to relax or relieve the force on the plunger 532 thereby allowing the spring 536 to move the diaphragm 480 from its retracted position (not shown) to its advanced position as shown in FIG. 11. Thus, liquid fuel that was previously received from the carburetor 18 and that was temporarily stored in the fuel reservoir 482 is discharged out of the pump 432 by movement of the diaphragm 480. In the advanced position, the liquid fuel substantially has been forced out of the fuel reservoir 482 through the outlet check valve 494 and outlet 498 by displacement of the diaphragm 480 from its previous retracted position to its new advanced position relatively against the housing 474. The fuel is forced out of the pump 432 and into the rest of the fuel system as described previously with respect to the first exemplary embodiment.

Upon engine shut down, such as when a user releases the safety bail 26 from the handle 28, the push pull wire 528 may be adapted to retract the plunger 532 rearward to allow the diaphragm 480 to move from its advanced position as shown in FIG. 11 to its retracted position (not shown). Those of ordinary skill in the art will recognize that suitable linkage may be interposed between the safety bail 26 and the plunger apparatus 522 to retract, rather than advance, the plunger 532 upon release of the safety bail 26. In any case, the plunger 532 rapidly retracts and, thus, permits the spring 486 to displace the diaphragm 480 rearwardly toward the cover 476, thereby increasing the volume of the fuel reservoir 482 and simultaneously decreasing the volume of the actuation chamber 484. As the volume of the fuel reservoir 482 increases, liquid fuel is drawn out of the carburetor bowl 52 through the drain outlet 68, fitting 72, and fuel line 40 and into the fuel reservoir 482 through the inlet 496 and inlet check valve 492.

It is also contemplated that the plunger could be electromechanically actuated instead of manually actuated with the push pull cable. For example, the plunger could be adapted for use with a solenoid wherein the stem of the plunger could be composed of magnetically responsive material for use as an armature of the solenoid. Those of ordinary skill in the art will recognize that push or pull solenoids could be adapted for use with the plunger stem, particularly latching solenoids to hold the plunger in place in either or both of the advanced and retracted positions. Alternatively, the plunger pump 432 could be manually actuated directly by a user's hand via a push-pull knob attached to the plunger 532.

### Fourth Exemplary Embodiment of a Mechanical Pump

FIGS. 12 through 22 illustrate a fourth exemplary embodiment of a mechanical pump in the form of a pneumatic pump 632, which is designed to operate on positive pressure pulses from an engine crankcase to discharge stored fuel. The pneumatic pump 632 does not include the valve pinholes of the previously described pneumatic pumps 32, 232 and, thus, generates relatively greater pressure than those pumps 32, 232. Moreover, the pneumatic pump 632 integrates the functionality of the shut off valve 20 of FIG. 2 so that the pneumatic pump 632 simultaneously or sequentially stops flow of liquid fuel to the carburetor 18 and draws liquid fuel therefrom substantially during shutdown of the engine. Accordingly, the pneumatic pump 632 is basically an integrated pump and valve assembly. This embodiment is similar in many respects to the embodiment of FIGS. 5 through 7 and like numerals between the embodiments may generally designate like or corresponding elements throughout the several views of the drawing figures. Additionally, some of the common subject matter may not be repeated herein below.

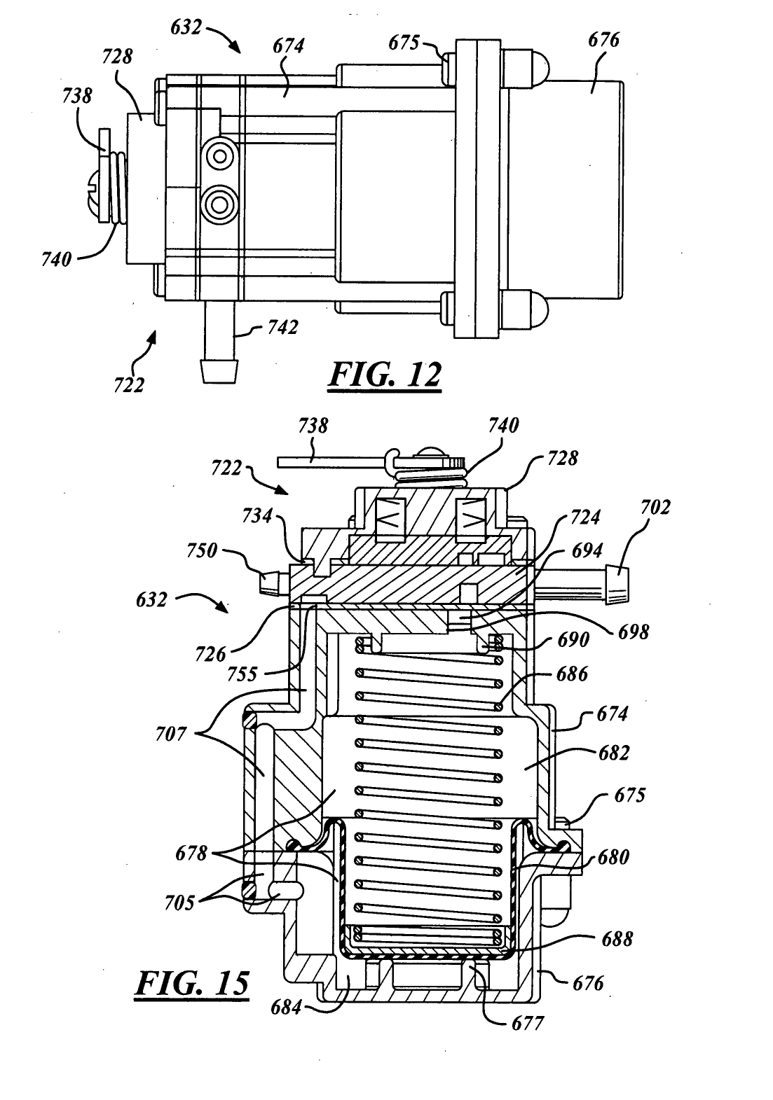

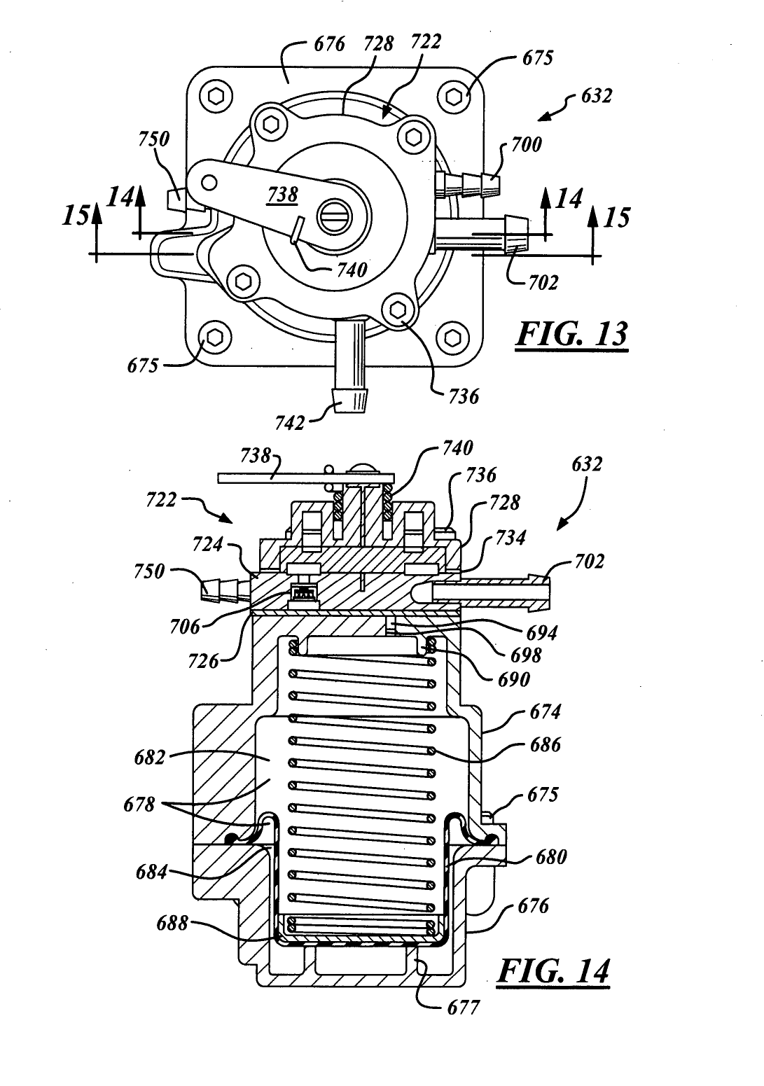

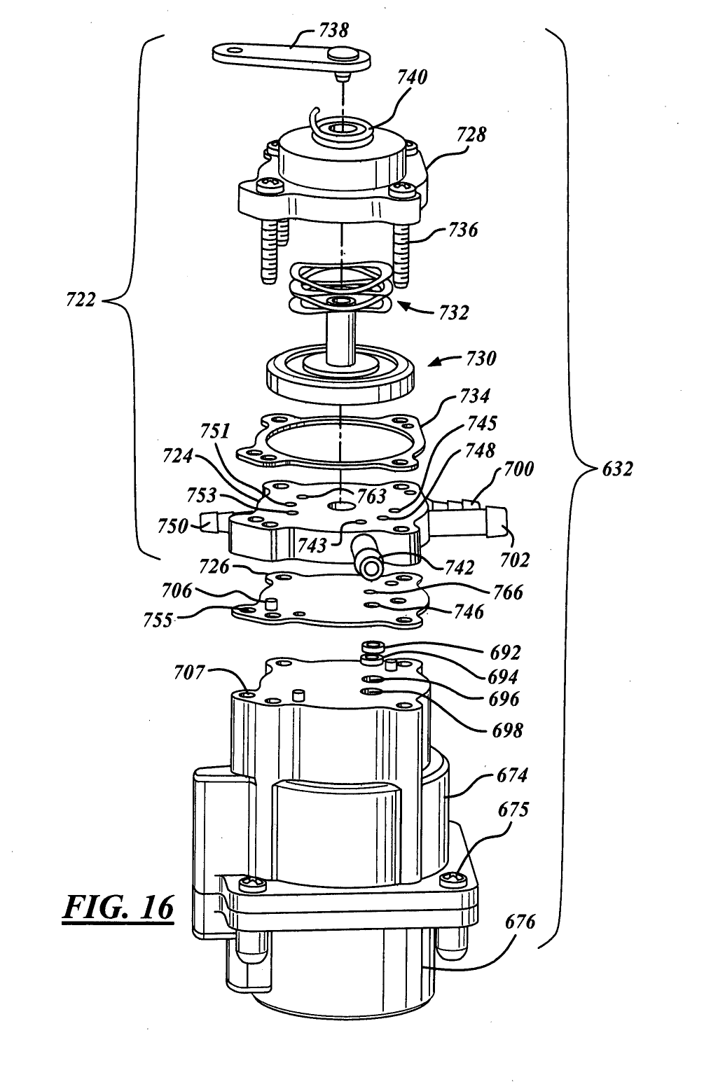

FIGS. 12 through 16 illustrate the pneumatic pump 632 in an engine off condition. The pump 632 includes a housing 674 and a cover 676 attached to the housing 674 with fasteners such as bolts 675 or the like, to define an interior 678. As shown in FIGS. 14 and 15, a diaphragm 680 is disposed within the interior 678 and is sealingly engaged between the cover 676 and the housing 674 to divide the interior 678 into a fuel reservoir 682 and an actuation chamber 684. A coiled compression spring 686 is disposed within the fuel reservoir 682 to yieldably bias the diaphragm 680 against the annular projection 677 of the cover 676. A spring plate 688 is received between the diaphragm and the adjacent end of the spring 686. At an opposite end of the spring 686, the spring 686 circumscribes an annular projection 690 of the housing 674. Referring to FIGS. 15 and 16, inlet and outlet check valves 692, 694 are disposed in fluid communication with the fuel reservoir 682 via inlets and outlets 696, 698 of the pump 632. The inlets and outlets 696, 698 communicate with respective inlet and outlet fittings 700, 702 as will be described below. At an opposite end of the pump 632, the cover 676 includes a pressure port 705 in communication with the actuation chamber 684 on one side and a pressure port 707 of the housing 674 on the other side.

Referring to FIGS. 12 through 16, a multi-functional shutoff valve 722 is provided to control flow of fuel to and from the carburetor 18 as well as control air pressure to and from an engine crankcase (not shown). Referring to FIG. 16, the shutoff valve 722 generally includes a valve plate 724 mounted against the housing 674 with a valve gasket 726 between them, and a valve cover 728 that traps a rotary valve 730 and an expanded metal spring 732, and is mounted against the valve plate 724 with a cover gasket 734 between them and fastened to the housing 674 with bolts 736 extending through apertures in the cover gasket 734, valve plate 724, and valve gasket 726. A lever 738 is fastened to the rotary valve 730 through the cover 728 and is biased to an engine off position, as shown, by a coiled torsional spring 740.

The engine on operation of the shutoff valve 722 and pump 632 is described below in reference to FIGS. 14 through 22, wherein the lever 738 may be rotated to the engine on position (not shown). The shutoff valve 722 controls flow of liquid fuel from the fuel tank 16 to the carburetor 18 and from the fuel reservoir 682 to either or both of the fuel tank 16 and carburetor 18. Liquid fuel flows into the pump 632 from the fuel tank 16 via a tank inlet fitting 742. The fuel flows through a portion of the valve plate 724 and out of an outlet fuel passage 743 into the rotary valve 730 through a fuel channel 744 thereof. The fuel flows through and out of the fuel channel 744 and back into the valve plate 724 through an inlet fuel passage 745. The fuel flows through a portion of the valve plate 724 and out the outlet fitting 702 to the carburetor 18. Additionally, liquid fuel flows out of the fuel reservoir 682 through the fuel outlet 698 and the outlet check valve 694 disposed therein, through an outlet aperture 746 of the valve gasket 726, into the valve plate 724 via a fuel channel 747 in a pump side of the valve plate 724, and out of the valve plate through an outlet fuel passage 748. The fuel then flows into the rotary valve 730 through the fuel channel 744 and back into the valve plate 724 through either or both of the fuel passages 743 and 745. Accordingly, the fuel from the fuel reservoir 682 may ultimately flow to either or both of the fuel tank 16 and carburetor 18 through the fuel fittings 742 and 702, respectively.

The shutoff valve 722 also controls flow of positive pressure pulses of air from the engine crankcase to the actuation chamber 684 of the pump 632. Pressure pulsed air flows into the valve plate 724 through a pneumatic fitting 750. The air flows out of the valve plate 724 through an outlet passage 751 and into the rotary valve 730. The pulsed air flows through a pneumatic channel 752 of the rotary valve 730 and back into the valve plate 724 through an inlet passage 753. The pulsed air then flows through an inlet check valve 706 disposed within the valve plate 724, through a pneumatic channel 754 in the pump side of the valve plate 724, through a pneumatic aperture 755 of the valve gasket 726 and into the housing 674 of the pump 632 via the housing pressure port 707. As best shown in FIG. 15, the pulsed air flows through the internal housing pressure port 707, through the internal cover pressure port 705, and into the actuation chamber 684. The pressurized air accumulates in the actuation chamber 684 to move the diaphragm 680 away from the cover 676 and toward the annular boss 690 of the housing 674 so as to displace the volume of fuel stored in the fuel reservoir 682 out of the pump 632 and to the tank 16 and/or carburetor 18.

The engine off operation of the shutoff valve 722 and pump 632 is described below in reference to FIGS. 14 through 22, wherein the lever 738 is shown rotated to the engine off position. The shutoff valve 722 stops flow of liquid fuel from both the tank 16 and the fuel reservoir 682 of the pump 632 to the carburetor 18. With the lever 738 in the off position, fuel flow to the carburetor 18 is stopped, wherein the carburetor inlet fuel passage 745 is stopped by an end portion 760 of a preferably elastomeric valve seal 761. Moreover, liquid fuel cannot flow into the fuel reservoir 682 from the outlet fuel passage 743 through the outlet fuel passage 748 because the outlet check valve 694, which communicates with the outlet fuel passage 748 via fuel channel 747 only permits flow out of the fuel reservoir 682. Accordingly, liquid fuel from the fuel tank 16 may not flow through the valve 722.

The shutoff valve 722 also controls release of pressurized air back to the engine crankcase from the actuation chamber 684 of the pump 632, thereby allowing the pump 632 to draw fuel out of the fuel bowl 52 of the carburetor 18. Referring again to FIG. 15, pressurized air flows into the shutoff valve 722 from the actuation chamber 684, through the internal pressure ports 705, 707. The pressurized air flows through the valve gasket aperture 755, into and through the channel 754 of the valve plate 724, around the check valve 706, through an outlet channel 762, and out the valve plate 724 via a pressure relief outlet passage 763. The pressurized air then flows through the pneumatic channel 752 in the rotary valve 730, back into the valve plate 724 through a pneumatic passage 751, and out of the shutoff valve 722 through the pneumatic fitting 750. Accordingly, the spring 686 is able to displace the diaphragm 680 in a direction relatively away from the housing 674 and toward the cover 676 until the diaphragm 680 locates against the annular projection 677 of the cover 676. Simultaneously, the movement of the diaphragm 680 pulls fuel through the carburetor inlet fitting 700 into the valve plate 724, through a fuel inlet channel 765 in the pump side of the valve plate 724, through a fuel inlet aperture 766 of the valve gasket 726, and through the inlet check valve 692 and inlet passage 696 into the fuel reservoir 682. Thus, a relatively high pressure pump is provided that integrates shutoff valve features and functionality to reduce the total number of individual components and connections within the fuel system.

### Exemplary Embodiment of a Mechanical Pump and Carburetor Unit

FIGS. 23 through 26 illustrate an exemplary embodiment of a combined carburetor and mechanical pump 800. A carburetor portion 818 is substantially similar to that described above with reference to FIGS. 1 through 4. Likewise, a mechanical pump portion 832 is substantially similar to that described above with reference to FIGS. 12 through 22. The basic differences between this embodiment and the related previously described embodiments, is that sub-assemblies are integrated into one larger assembly to reduce the quantity of components in the fuel system, such as fluid lines and fittings. This embodiment is nearly identical in many respects to the embodiments of FIGS. 1 through 4 and FIGS. 12 through 22 and like numerals between the embodiments may generally designate like or corresponding elements throughout the several views of the drawing figures. Additionally, much of the common subject matter may not be repeated herein below.

The carburetor 818 includes a carburetor body 844 that includes a choke lever 846 for operating a choke valve 847, a throttle lever 848 for operating a throttle valve (not shown), and a preferred float bowl or fuel bowl 852 carried by the body 844. The fuel bowl 852 is preferably angled according to the preferred design and construction as previously described herein.

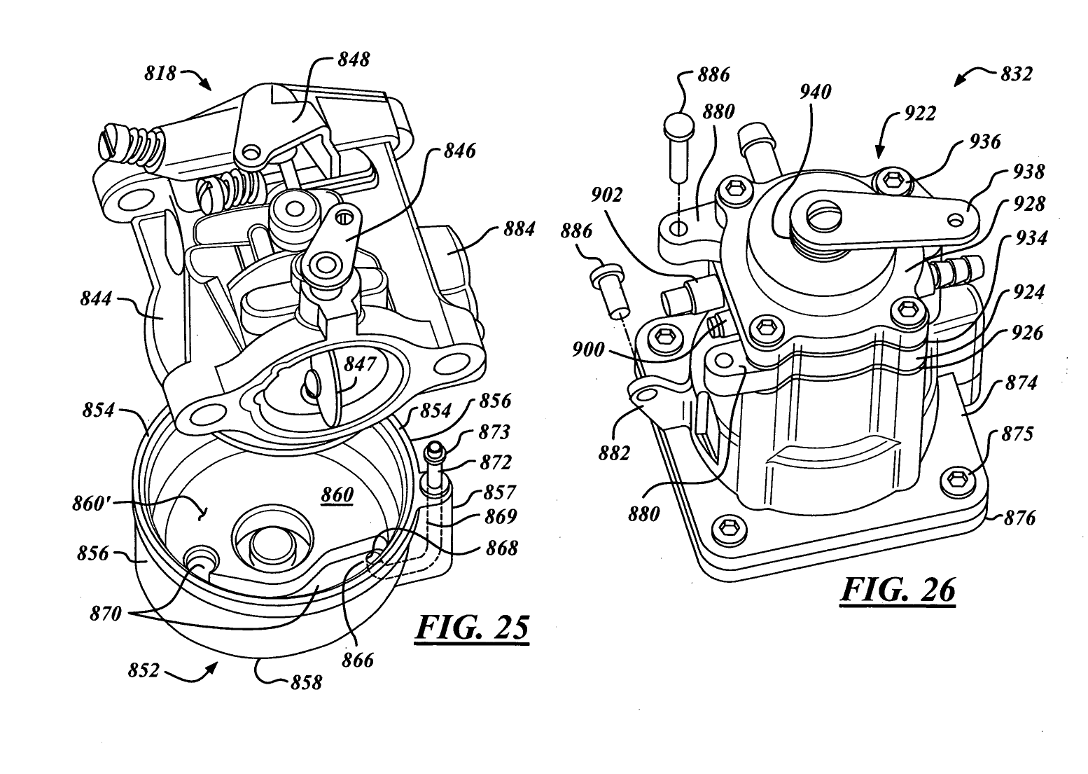

As best shown in FIG. 25, the fuel bowl 852 includes an open end 854, a wall 856 extending downward from the open end 854, and a closed end 858 terminating the wall 856. On one side of the fuel bowl 852, the wall 856 includes an extension 857 as will be discussed further below. The closed end 858 includes an inside bottom surface 860, 860′ that is sloped as discussed previously herein. The fuel chamber of the carburetor 818 is basically defined between the inside bottom surface 860, 860′ of the fuel bowl 852 and the body 844.

The fuel bowl 852 is provided with a low-lying collection area 866 and a fuel drain outlet 868 disposed substantially at the low-lying collection area 866 to enable substantially complete drainage of liquid fuel out of the fuel bowl 852. The low-lying collection area 866 is in fluid communication with the fuel chamber via a channel 870 provided in the closed end 858 of the fuel bowl 852. The channel 870 slopes away from the inside bottom surface 860′ toward the low-lying collection area 866 to enable liquid fuel to exit the fuel bowl 852 through a fitting 872. The fitting 872 includes an O-ring 873 and is carried by the extension 857 and, on one end, is in communication with a bowl outlet passage 869 provided in the fuel bowl 852. An opposite end of the fitting 872 is adapted for insertion into one end of a drain passage (not shown) provided in the carburetor body 844. The outlet passage 869 communicates the fitting 872 to the low-lying collection area 866 through the drain outlet 868. To more fully ensure substantially complete drainage of liquid fuel from the carburetor 818, it is further desirable to provide means for removing the liquid fuel from the fuel bowl 852.

Such means may include the pump 832, which includes a housing 874 and a cover 876 attached thereto with fasteners 875. A multi-functional shutoff valve 922 is provided to control flow of fuel to and from the carburetor 818 as well as to control air pressure pulses to and from an engine crankcase (not shown). The shutoff valve 922 generally includes a valve plate 924 mounted against the housing 874 via a valve gasket 926, and a valve cover 928 that is mounted against the valve plate 924 via a cover gasket 934 and to the housing 874 with bolts 936. A lever 938 extends through the cover 928 and is biased to an engine off position, as shown, by a coiled torsional spring 940.

The pump 832 is adapted to be mounted directly to the carburetor 818. A drain fitting 900 and a carburetor fuel supply fitting 902 extend outwardly from the housing 874 and are adapted for insertion into respective drain and supply passages (not shown) in the carburetor body 844. The drain fitting 900 is thus in fluid communication with the drain 868 of the fuel bowl via the outlet passage 869, fitting 872, and body drain passage (not shown). Similarly, the fuel supply fitting 902 is in fluid communication with the carburetor fuel chamber via the body supply passage (not shown) which is in fluid communication with the typical chamber inlet passage (not shown) in the carburetor body 844. The housing 874 includes horizontal mounting extensions 880 and a vertical mounting extension 882. The horizontal mounting extensions 880 are adapted for mounting against a corresponding mounting extension 884 of the carburetor 818, and the vertical mounting extension is adapted for mounting against a corresponding mounting extension (not shown) of the carburetor 818. Bolts 886 preferably extend through the housing extensions 880, 882 and thread into the carburetor 818.

The pump 832, including the multi-functional shutoff valve 922 substantially similar to the pump 732 and valve 722 which was described with regard to the previous embodiment and which is incorporated by reference herein.

### Second Exemplary Embodiment of a Fuel System

FIGS. 27 through 30 illustrate in block diagram, another exemplary embodiment of a fuel system that generally depicts many of the features of the previous embodiments and that includes some additional features. This embodiment is similar in many respects to the previously described embodiments and like numerals between the embodiments generally designate like or corresponding elements throughout the several views of the drawing figures. Accordingly, some common subject matter may not be repeated in detail herein below.

The block diagrams of FIGS. 27 through 30 generally include an engine-powered apparatus or equipment 1012 having a combustion engine 1014 for powering the equipment 1012 and a fuel system for storing and distributing fuel to the engine 1014. The fuel system includes a fuel tank 1016 for storing fuel, fuel lines or fluid paths for carrying fuel, a carburetor 1018 for mixing air with the fuel, and a combined fuel pump and valve actuation device 1032 in fluid communication therebetween for controlling evaporative emissions of fuel. The fuel tank 1016 preferably includes a pressure relief valve 1043 that opens at internal fuel tank pressures in excess of four psig. The carburetor 1018 includes a carburetor body 1044, an air cleaner 1045 mounted to the body 1044 in fluid communication therewith as is well known in the art, and a fuel bowl 1052 mounted thereto in fluid communication with the body 1044.

The pump and valve actuation device 1032 preferably includes an interior 1078 divided by diaphragm 1080 into a reservoir 1082 for fuel from a carburetor fuel bowl, and an actuation chamber 1084. The device 1032 also preferably includes a valve actuation portion 1020 including three actuated valves and three check valves. An actuated fuel tank vapor vent valve 1176 is disposed in a fuel tank vapor fluid path 1178, 1178′ extending between an upper portion of the fuel tank 1016 and the air cleaner 1045. An actuated fuel supply valve 1041 is disposed in a fuel supply fluid path 1038, 1038′ extending between a lower portion of the fuel tank 1016 and the carburetor body 1044.

An actuated pressurized air valve 1161 is in a branched pressurized air fluid path 1153, 1153′, 1153″ between the actuation chamber 1084 and an engine crankcase 1015. The air valve 1161 is adapted to communicate the actuation chamber 1084 with one or the other of a pressure pulse branch 1153′ or a pressure relief branch 1153″, but preferably not both simultaneously. In other words, the air valve 1161 can open communication between the actuation chamber 1084 and crankcase 1015 through the relief passage 1153″, but simultaneously or synchronously closes communication between the actuation chamber 1084 and crankcase 1015 through the pressure pulse passage 1153′.

The pump and valve actuation device 1032 also includes check valves. A pressure pulse check valve 1106 is in the pulse branch 1153′ of the branched fluid path 1153, 1153′, 1153″ between the actuation chamber 1084 and the engine crankcase 1015. A fuel reservoir inlet check valve 1092 is in a carburetor drain fluid path 1091, and a fuel reservoir outlet check valve 1094 is in a recycle fluid path 1093.

FIG. 27 illustrates the equipment 1012 in an engine running mode, wherein several fluid paths are preferably fully open. In this mode, liquid and vapor fuel flows from the fuel tank 1016 to the carburetor 1018 when the engine 1014 is running. The pump and valve actuation device 1032 may be automatically actuated such as by a solenoid, or may be manually actuated such as by a cable attached to a remote handle and lever of the equipment, so as to permit flow of liquid fuel and fuel vapors when the engine is running.

The pump and valve actuation device 1032 permits fuel vapor to flow from the fuel tank 1016, through the tank vapor inlet conduit 1178, through the fully open fuel tank vapor vent valve 1176, and through a tank vapor outlet conduit 1178′, to the air cleaner 1045. Alternatively, it is contemplated that the outlet conduit 1178′ may be communicated instead to a carbon canister (not shown), the atmosphere, an engine intake port, any desired portion of the carburetor, or the like.

Also, the pump and valve actuation device 1032 permits liquid fuel to flow from the fuel tank 1016 through a liquid fuel inlet conduit 1038, through the fully open carburetor fuel inlet valve 1041, and through a liquid fuel outlet conduit 1038′, to the carburetor fuel chamber defined between the carburetor body 1044 and fuel bowl 1052, preferably by way of the carburetor body 1044 and a float valve (not shown).

The check valves of the valve actuation device automatically permit or prevent flow of fuel or pressurized air therethrough. In the engine running situation, positive pulsed or pressurized air flows from the crankcase 1015 through the check valve 1106, through the open pressurized air valve 1161 and into the actuation chamber 1084 to keep the diaphragm 1080 in an advanced position. The air valve 1161 is open to permit pulses of air to flow to the actuation chamber 1084. The internal pressure of the chamber 1084 is preferably about 0.5 psig.

FIG. 28 illustrates the equipment 1012 in an engine shutdown mode, wherein the actuated valves are closing or have been closed. In this mode, neither liquid nor vapor fuel is permitted to flow from the fuel tank 1016 to the carburetor 1018. The fuel tank vapor vent valve 1176 of the pump and valve actuation device 1032 closes so as to stop fuel vapor from flowing from the fuel tank 1016, through the tank vapor inlet conduit 1178, and through the tank vapor outlet conduit 1178′, to the air cleaner 1045. Also, the carburetor fuel inlet valve 1041 closes to stop the flow of liquid fuel from the fuel tank 1016 through the liquid fuel inlet conduit 1038, and through the liquid fuel outlet conduit 1038′, to the carburetor fuel chamber. As discussed with reference to the previously disclosed embodiments, pressurized air from the actuation chamber 1084 is permitted to flow through the actuated pressurized air valve 1161 and back into the engine crankcase 1015 to enable the diaphragm 1080 to be displaced and thereby draw fuel out of the carburetor bowl 1052 into the reservoir 1082 through the inlet check valve 1092, while the outlet check valve 1094 prevents fuel from being drawn into the reservoir 1082 through the recycle fluid path 1093. During engine shutdown, the internal pressure of the chamber 1084 decreases from about 0.5 psig to about 0.0 psi.

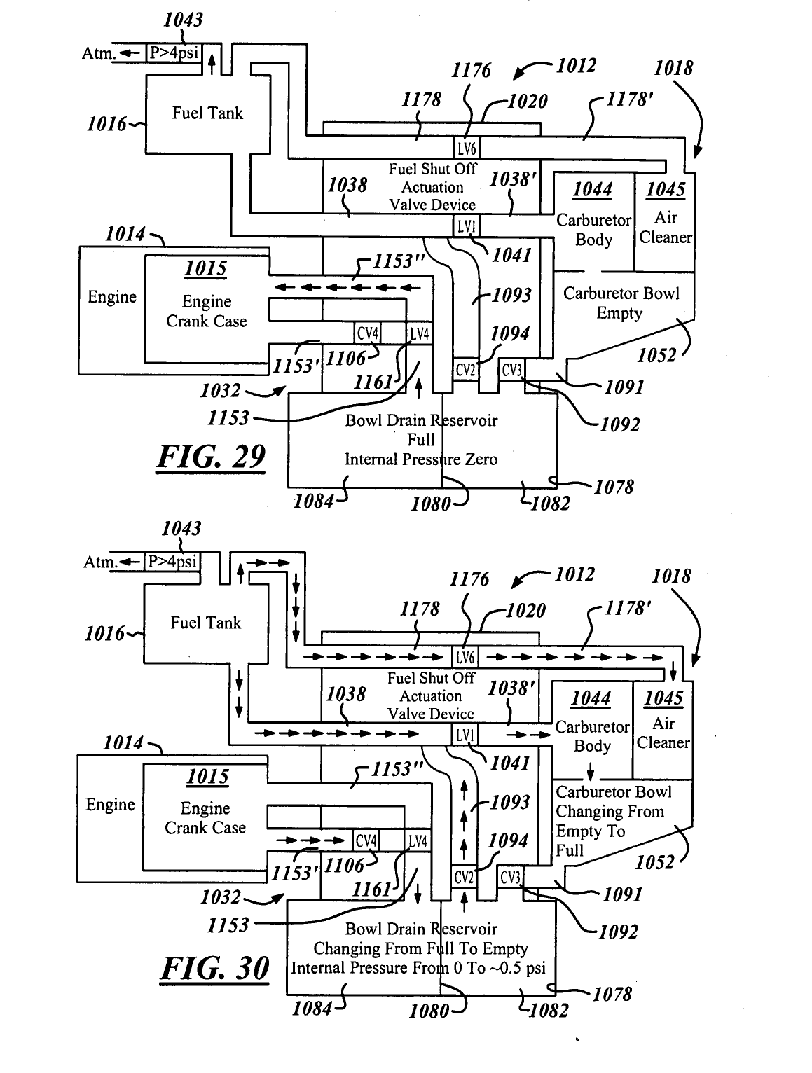

FIG. 29 illustrates the equipment 1012 in an engine off mode, wherein the actuated valves are closed. As with the previous mode, in this mode, neither liquid nor vapor fuel is permitted to flow from the fuel tank 1016 to the carburetor 1018. The fuel tank vapor vent valve 1176 of the pump and valve actuation device 1032 is fully closed so as to stop fuel vapor from flowing from the fuel tank 1016, through the tank vapor inlet conduit 1178, and through the tank vapor outlet conduit 1178′, to the air cleaner 1045. Also, the carburetor fuel inlet valve 1041 is closed to stop flow of liquid fuel from the fuel tank 1016 through the liquid fuel inlet conduit 1038, and through the liquid fuel outlet conduit 1038′, to the carburetor fuel chamber. Any air from the actuation chamber 1084 is still permitted to flow through the open pressurized air valve 1161 and back into the engine crankcase 1015. By this point, all or substantially all fuel has been drained out of the carburetor bowl 1052 through the passage 1091 and inlet check valve 1092 and is stored and sealed within the fuel reservoir 1082. Any build up of vapor pressure within the fuel reservoir 1082 is sealed by closing of the inlet check valve 1092 and is sealed from the carburetor inlet by the closed carburetor inlet valve 1041. The fuel reservoir 1082 remains in communication with the fuel tank 1016 through the check valve 1094. The internal pressure of the chamber 1084 is preferably only the head pressure due to the fuel in the fuel tank 1016. Shutoff of fuel supply to the carburetor and withdrawal and storage of the bowl fuel reduces diurnal losses by preventing fuel and/or fuel vapor from escaping from the fuel chamber.

FIG. 30 illustrates the equipment 1012 in an engine startup mode, wherein several fluid paths are open or are opening. Like the engine running mode, in this mode, liquid and vapor fuel flows from the fuel tank 1016 to the carburetor 1018. The pump and valve actuation device 1032 permits fuel vapor to flow from the fuel tank 1016, through the tank vapor inlet conduit 1178, through the open or opening fuel tank vapor vent valve 1176, and through the tank vapor outlet conduit 1178′, to the air cleaner 1045. Also, the pump and valve actuation device 1032 permits liquid fuel to flow from the fuel tank 1016 through the liquid fuel inlet conduit 1038, through the open or opening carburetor fuel inlet valve 1041, and through a liquid fuel outlet conduit 1038′, to the carburetor fuel chamber. Pulsed or pressurized air flows through the check valve 1106, through the open air valve 1161 and into the actuation chamber 1084 to displace the diaphragm 1080. The diaphragm 1080 is displaced to discharge fuel from the fuel reservoir 1082 through the check valve 1094, conduit 1093, and into conduit 1038 upstream of valve 1041.

The present disclosure may also incorporate various components and features of the fuel system described in U.S. patent application Ser. No. 10/955,781, filed Sep. 30, 2004, and entitled CONTROLLING EVAPORATIVE EMISSIONS IN A FUEL SYSTEM, which is assigned to the assignee hereof and is hereby incorporated herein by reference.

### Third Exemplary Embodiment of a Fuel System

FIG. 31 schematically illustrates another exemplary embodiment of a fuel system that generally depicts many of the features of the previous embodiments and that includes some additional features. This embodiment is similar in many respects to the previously described embodiments and like numerals between the embodiments generally designate like or corresponding elements throughout the several views of the drawing figures. Accordingly, some common subject matter may not be repeated in detail herein below.

Referring now to FIG. 31, a gravity draining fuel system includes a fuel tank 1216, a carburetor 1218 generally elevated with respect to the fuel tank 1216, a pneumatically-actuated pump 1231 positioned generally beneath the fuel tank 1216 in fluid communication between the carburetor 1218 and the fuel tank 1216, and a four-way fitting 1233 positioned generally beneath the fuel tank 1216 in fluid communication between the fuel tank 1216 and carburetor 1218. In general, when the engine is operating liquid fuel 1234 flows from the fuel tank 1216 through a fuel filter 1236, fuel line 1238, pump 1231, and four-way valve 1233, into the carburetor 1218. But when the engine is not operating, liquid fuel drains out of the carburetor 1218 and back to the fuel tank 1216 to substantially reduce evaporative emission of fuel from the carburetor 1218.

The fuel tank 1216 is provided for containing liquid and vapor fuel and may be sealed with any suitable cap or closure but is preferably sealed with a non-vented cap 1242, which seals completely against a spout of the tank 1216 as shown. The fuel tank 1216 may be vented through a float ball check valve 1243, which communicates fuel vapor from the interior of the fuel tank 1216 to a carbon canister (not shown) through a vapor line 1241. The valve 1243 may be a multiple function valve such as an atmospheric inlet and vapor outlet valve. For example, the valve 1243 may be a roll over and anti-splash valve containing an anti-splash ball valve, as shown, which does not allow liquid fuel to exit the fuel tank 1216 during an extreme tilt angle or fuel splash. One preferred type of the valve 1243 is disclosed in U.S. patent application Ser. No. 10/955,795, filed on Sep. 29, 2004, entitled EVAPORATIVE EMISSION CONTROLS, which is assigned to the assignee hereof and is hereby incorporated herein by reference. Such a valve permits vapors to flow therethrough and to a carbon canister when pressure in the fuel tank 1216 exceeds a predetermined threshold. The fuel tank 1216 allows for continuous two way venting to assure that neither a substantial positive nor a substantial negative pressure is allowed to build up inside the fuel tank 1216, wherein the air and/or fuel vapor above the level of fuel 1234 in the fuel tank 1216 is substantially at atmospheric pressure.

Referring to FIG. 32, the fuel pump 1231 includes inlet and outlet check valves 1277 and 1279 that are biased in closed positions against passages 1281 and 1283 respectively. The fuel pump 1231 is activated by pulses from the crankcase of a two or four stroke engine (not shown) or the intake pulses from a four stroke engine (not shown) routed thru pulse line 1275. In any case, the fuel pump 1231 may be substantially the same as that disclosed in U.S. patent application Ser. No. 10/955,133, filed on Sep. 30, 2004, and entitled EVAPORATIVE EMISSIONS CONTROLS IN A FUEL SYSTEM, which is assigned to the assignee hereof and is hereby incorporated herein by reference.

Referring to FIG. 34, the four way fitting 1233 provides a device to route flow of fuel among the fuel tank 1216, carburetor 1218, and pump 1231. The four way fitting 1233 includes a housing 1301 and several fittings fitted thereto including an inlet fitting 1303, an outlet fitting 1305, a bypass fitting 1307, and a return fitting 1309. The inlet and outlet fittings 1303, 1305 define a through passage, the bypass fitting 1307 defines a bypass passage, and the return fitting 1309 defines a return passage. A bypass check valve 1311 is disposed within the housing 1301 between the through passage and the bypass passage to prevent fuel flow from the fuel tank 1216 further into the housing 1301 and to permit fuel flow into the fuel tank 1216. A return check valve 1313 is disposed within the housing 1301 between the return passage and the through passage to prevent fuel flow from the housing 1301 through the return passage and to permit fuel flow through the return passage further into the housing 1301. The check valves 1311, 1313 are preferably identical and each includes a restriction orifice 1315 to allow fuel flow therethrough and a valve disc 1317 to prevent fuel flow therethrough. It is contemplated that the valves 1311, 1313, could also be constructed integrally with the fuel pump 1231, and the pump/valve integrated assembly could be placed inside the fuel tank 1216.

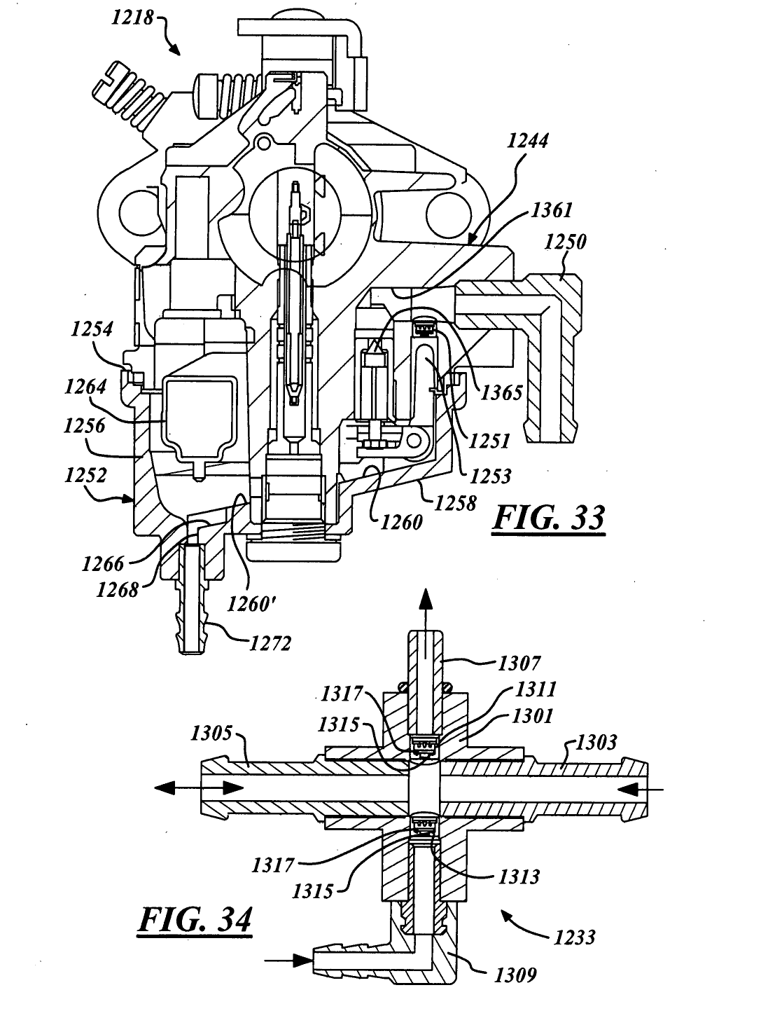

Referring to FIG. 33, aside from the novel features described herein, the carburetor 1218 may otherwise be constructed consistent with a low evaporative emission float-bowl carburetor, as discussed previously herein. In general, however, the carburetor 1218 includes a carburetor body 1244 and a fuel inlet fitting 1250 that communicates with a bowl vent check valve 1251 disposed in a bowl vent passage 1253 in the carburetor body 1244 and with an inlet needle valve 1365 disposed within a fuel inlet passage 1361. The carburetor 1218 also includes a preferred float bowl or fuel bowl 1252 carried by the body 1244, and a combination float arm and float 1264.

The fuel bowl 1252 may be of preferred design and construction including an open end 1254, a wall 1256 extending downward from the open end 1254, and a closed end 1258 terminating the wall 1256, wherein the closed end 1258 includes an inside bottom surface 1260, 1260′ that is sloped toward a low-lying collection area 1266 and a fuel drain outlet 1268 disposed substantially at the low-lying collection area 1266 through the bottom of the fuel bowl 1252 as opposed to through the side as with other embodiments. As with previous embodiments, the fuel drain outlet 1268 is positioned in such proximity to the low-lying collection area 1266 so as to enable substantially complete drainage of liquid fuel out of the fuel bowl 1252 through the fuel drain outlet 1268. A bowl outlet fitting 1272 is mounted to the bottom of the fuel bowl 1252 in communication with the drain outlet 1268. The fuel chamber of the carburetor 1218 is basically defined between the inside bottom surface 1260, 1260′ of the fuel bowl 1252 and the body 1244.

Referring to FIGS. 31 through 34 generally, during engine operation, fuel exits the fuel tank 1216 thru the standard fuel pick-up and filter 1236 and fuel line 1238 to the fuel pump 1231. The pump 1231 pumps fuel to the carburetor 1218 thru fuel line 1238′, four way fitting 1233, and fuel line 1238″. In each of the check valves 1311, 1313 of the four way fitting, the restriction 1315 is preferably kept to a minimum (e.g. ˜0.020″ or smaller) to facilitate starting of the engine, especially hand cranking of the engine. Because the fuel lines 1238, 1238′, 1238″ and the carburetor bowl 1252 are ordinarily empty upon startup, fuel is pumped to fill these components during the starting process. Accordingly, the restrictions 1315 are preferably small enough to prevent complete drain back of the fuel between each pull of the engine starting rope (not shown). A starting fuel primer (not shown), which is common on lawn and garden equipment preferably would aid in starting the engine in this embodiment. While the check valves 1311, 1315 are preferably identical, the diameter of the restrictions 1315 may have different values depending on the check valve 1311 or 1313.

Fuel pumped from the pneumatic pump 1231 can also flow through the bypass check valve 1311 of the four way fitting 1233 back to the fuel tank 1216 through the bypass fitting. Nonetheless, the pump 1231 is preferably sized such that the output capacity of the pump 1231 is sufficient to supply adequate fuel flow and pressure up to the carburetor 1218, despite the flow of bypass fuel thru the check valve 1311. The fuel pressure delivered from the fuel pump 1231 acts against the disk 1317 of the return check valve 1313 and is sufficient to keep the valve 1313 closed and block fuel flowing from fuel line 1240 through the four way fitting 1233. Even if there is some small flow out of the fuel bowl 1252 thru the outlet fitting 1272, the fuel pump 1231 is preferably sized to deliver adequate fuel flow and pressure to the carburetor inlet. The restriction orifice 1315 in the check valve 1313 is sized to prevent rapid flow of fuel from the fuel bowl 1252 even if the fuel pressure should momentarily drop, such as between starting pulls. The bowl vent check valve 1251 in the carburetor body 1244 does not allow fuel to bypass the inlet needle 1365 as it is positioned to allow flow only in the opposite direction, such as fuel vapor flow. Accordingly, the float bowl 1252 of the carburetor 1218 is filled during all phases of engine operation with the carburetor inlet needle valve 1365 regulating the flow of incoming fuel.

Still generally referring to FIGS. 31 through 34, when the engine is turned off, the pulses from the crankcase (or the engine revolutions driving a mechanical pump or the electric current driving an electric pump) cease and fuel flow thru the pump 1231 stops. Also, the tank pressure above the fuel level 1234 is atmospheric, and back pressure on the disc 1317 of the return check valve 1313 drops to a value equal to the fuel head between the top of the fuel level 1234 in the fuel tank 1216 and the valve 1313. Also, one or more of the inlet or outlet check valves 1277 or 1279 of the fuel pump 1231 or the check valves 1311 or 1313 of the four way fitting 1233 is in fluid communication between the fuel tank 1216 and the carburetor 1218 and is adapted to prevent flow of fuel into the carburetor 1218 at least when the internal combustion engine is not operating.

Moreover, fuel drains from the carburetor bowl 1252 and flows thru the return fuel line 1240, through the return check valve 1313, through the bypass valve 1311, and through the bypass passage back to the fuel tank 1216. The fuel in fuel line 1238″ drains back to the fuel tank 1216 as air from the carburetor bowl vent passage 1253 flows thru the bowl vent check valve 1251, thereby preventing a vacuum build up on the tip of the inlet needle valve 1365 that is exposed to the fuel inlet passage 1361. The vent check valve 1251 is especially preferable in cases of high fuel lift between the fuel tank 1216 and the carburetor 1218 on the order of five feet or more. Normally, however, fuel draining from the carburetor bowl 1252 thru the outlet fitting 1272 will lower the fuel level in the fuel bowl 1252, thereby lowering the float 1264 and, thus, opening the inlet needle valve 1365 and allowing air flow into fuel line 1238″ to allow fuel to drain back to the fuel tank 1216.

The fuel does not all drain back into the fuel tank 1216 through the bypass valve 1311. The fuel in lines 1238″ and 1240 will drain to a level equal to the height of the fuel 1234 in the fuel tank 1216. By cleverly constructing the fuel pump 1231 and valves 1311, 1313, and by keeping the inside diameter of the fuel lines 1238, 1238′, 1238″, 1240 to a minimum acceptable size, the fuel remaining in the fuel lines 1238, 1238′, 1238″, 1240 is kept to a minimum. If, by chance, some fuel in the fuel lines 1238, 1238′, 1238″, 1240 heats up and escapes to the atmosphere during diurnal storage, that amount of fuel is prevented from being replenished by additional fuel in the tank 1216 by the fuel pump valves 1277, 1279. Accordingly, this fuel system automatically drains the carburetor bowl 1252 at engine shut down by gravity draining, thereby limiting the evaporative emissions loss to the atmosphere.

### Fourth Exemplary Embodiment of a Fuel System

FIG. 35 illustrates in a block diagram, and FIG. 36 illustrates in a pictorial schematic, another exemplary embodiment of a fuel system that generally depicts many of the features of the previous embodiments and that includes some additional features. This embodiment is similar in many respects to the previously described embodiments and like numerals between the embodiments generally designate like or corresponding elements throughout the several views of the drawing figures. Accordingly, some common subject matter may not be repeated in detail herein below.

The block diagram of FIG. 35 generally includes an engine-powered apparatus or equipment 1412 having a combustion engine (not shown) for powering the equipment 1412 and an electrically-actuated or solenoid-actuated fuel system for storing and distributing fuel to the engine. The fuel system includes a fuel tank 1416 for storing fuel, fuel lines or fluid paths for carrying fuel, a carburetor 1418 for mixing air with the fuel, a valve actuation device 1420 in fluid communication therebetween and actuated by a solenoid 1421 for controlling evaporative emissions of fuel, and a mechanical pump 1432 in fluid communication therebetween and actuated by a second solenoid 1435 for actively draining the carburetor 1418 of fuel.

The components of the system include various sub-components. The fuel tank 1416 preferably is communicated to a carbon canister 1417 via a vent line 1578. The carburetor 1418 includes a carburetor body 1444, an air cleaner 1445 mounted to the body 1444 in fluid communication therewith as is well known in the art, and a fuel bowl 1452 mounted thereto in fluid communication with the body 1444. The pump 1432 preferably includes an interior 1478 divided by diaphragm 1480 into a reservoir 1482 for fuel from a carburetor fuel bowl, and an actuation chamber 1484. The pump 1432 also includes a fuel reservoir inlet check valve 1492 in a carburetor drain fluid path 1491, and a fuel reservoir outlet check valve 1494 in the recycle fluid path 1493. The valve actuation device 1420 includes an actuated fuel supply valve 1441 disposed in a fuel supply fluid path 1438, 1438′ extending between a lower portion of the fuel tank 1416 and the carburetor body 1444.

The fuel system uses the two solenoids 1421 and 1435 which are wired to be electrically switched on and off simultaneously. The solenoids 1421, 1435 may be electrically connected to a power supply such as a battery of the equipment 1412, as is known to those of ordinary skill in the art. The first solenoid 1421 operates the fuel supply valve 1441 between the fuel tank 1016 and the fuel inlet to the carburetor body 1444. The second solenoid 1435 operates the diaphragm 1480 of the fuel bowl drain pump 1432.

When engine controls (not shown) are in the engine “ON” position, electric current flows to both solenoids 1421, 1435 applying a force to solenoid armatures 1423, 1437 in a direction tending to center the armatures 1423, 1437 in solenoid wire windings 1425, 1439. The armature 1423 of the first solenoid 1421 is attached by means of a mechanical link 1537 to a lever 1538 that controls the fuel supply valve 1420, which lever 1538 is biased in a closed position by means of a torsional spring 1540. When the engine is switched “ON”, the armature 1423 is pulled into the center of the solenoid winding 1425, thereby overcoming the torsional bias of the spring 1540 and, thus, opening the valve 1420. Preferably, the armature 1423 reaches full travel very quickly, thus opening the valve very quickly (i.e. ˜one second or less). The armature 1437 of the second solenoid 1435 is attached mechanically to a plunger 1532 on an actuation side of the diaphragm 1480 of the pump 1432. The diaphragm 1480 is normally biased in the interior 1478 by an internal compression spring 1486. The armature 1437 applies a force that moves the diaphragm 1480 to the position shown to empty the reservoir 1482 and thereby displace fuel through the outlet check valve 1494 back to or toward the fuel tank 1416. The armature 1437 of the second solenoid 1435 moves slower to its centered position than does the armature 1423 of the first solenoid 1421, because displacing the reservoir fuel through the outlet check valve 1494 may take several seconds to perhaps a minute or more.

When the engine controls (not shown) are in the engine “OFF” position, there is no electrical current flowing to either of the solenoids 1421, 1435. In this mode, there is no force being applied to either armature 1423, 1437 and the armatures 1423, 1437 are easily moved by the respective biasing springs 1540, 1486 of the fuel supply valve 1420 and of the pump 1432. The supply valve 1420 is switched to the off position quickly and the reservoir 1482 of the pump 1432 is filled with fuel from the carburetor bowl 1452 through the inlet check valve 1492 relatively slowly.

It is contemplated, however, that if both armatures 1423, 1437 were able to move rapidly to their full centered positions, then only one solenoid would be required with mechanical linkage from the solenoid to both the valve 1420 and pump 1432. Even with the valve 1420 and pump 1432 requiring vastly different actuation times, one solenoid could be used if the armature thereof was allowed to move quickly and mechanical linkage to the slower moving pump 1432 stored the energy to complete the operation. For instance, the mechanical linkage could be a lost-motion linkage and/or could include a compressed spring which would slowly uncompress to complete the diaphragm movement function.

### CONCLUSION

One or more of the various embodiments described herein may provide one or more of the advantages described herein below. During startup and/or running of an internal combustion engine, at least one or more of the following actions may be permitted: venting of fuel vapor from a fuel tank, and supplying fuel to the carburetor from at least one of the fuel tank and a fuel bowl drain reservoir. Conversely, during shut down and/or when the internal combustion engine is not operating, a carburetor fuel bowl is drained of substantially all of its liquid fuel to at least one of the fuel tank and the fuel bowl drain reservoir, and at least one or more of the following actions are prevented: venting of fuel vapor from the fuel tank, supplying fuel from the carburetor to at least one of the fuel tank and a fuel bowl drain reservoir. Accordingly, evaporative emissions from a carburetor of a fuel system are able to be reduced. Moreover, the various valves are automatically closed at the valve or valve device itself to make the evaporative emission controls fail safe. Finally, the multi-action valve arrangement of the above-described embodiments of the present invention easily integrates multiple valve actions into one mechanism.

It is to be understood that the foregoing description is not a description of the invention, but is a description of one or more presently preferred embodiments of the invention. Accordingly, the invention is not limited to the particular exemplary embodiment(s) disclosed herein, but rather is defined solely by the claims below. In other words, the statements contained in the foregoing description relate to particular exemplary embodiments and are not to be construed as limitations on the scope of the invention as claimed below or on the definition of terms used in the claims, except where a term or phrase is expressly defined above or where the statement specifically refers to “the invention.” Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components, elements, or items. Moreover, directional words such as top, bottom, upper, lower, radial, circumferential, axial, lateral, longitudinal, vertical, horizontal, and the like are employed by way of description and not limitation. Other terms are to be construed using their broadest reasonable meaning unless they are used in a context that requires a different interpretation. When introducing elements of the present invention or the embodiment(s) thereof, the articles “a,” “an,” “the,” and “said” are intended to mean that there are one or more of the elements.

While the forms of the invention herein disclosed constitute presently preferred embodiments, many others are possible. The method is preferably carried out using various elements of the system, and, in turn, the system preferably includes various elements of the apparatus, although the present invention contemplates a myriad of alternatives. In other words, any given manifestation or embodiment of the present invention is not to be read as limited to the limitations of other embodiments of the present invention. More specifically, any given embodiment disclosed herein, and any features associated therewith, are interchangeable and incorporated by reference into any other given embodiment disclosed herein. Accordingly, the present invention contemplates that each feature of each embodiment disclosed herein is combinable with other features of the other embodiments disclosed herein. Also, it is contemplated that the present invention can be adapted for use with carburetors that may include an integral fuel bowl as opposed to a fuel bowl that is separately mounted to the carburetor body. It is not intended herein to mention all the possible equivalent forms or ramifications of the invention. It is understood that terms used herein are merely descriptive, rather than limiting, and that various changes may be made without departing from the spirit and scope of the invention as defined by the following claims.

1. A method of controlling evaporative emissions of volatile fuel from a fuel system including a fuel tank and a carburetor for use with an internal combustion engine, the method comprising the steps of:
containing fuel within the fuel tank and within the carburetor;
permitting flow of fuel into the carburetor, at least when the internal combustion engine is operating;
preventing flow of fuel into the carburetor, at least when the internal combustion engine is not operating; and
permitting flow of fuel out of the carburetor and into a receptacle, substantially during shutdown of the internal combustion engine.

2. The method of claim 1 further comprising withdrawing fuel out of the carburetor and into the receptacle, substantially during shutdown of the internal combustion engine.

3. The method of claim 2 wherein the withdrawing step includes using a pneumatically-actuated diaphragm pump.

4. The method of claim 2 wherein the withdrawing step includes using an electrically-actuated pump.

5. The method of claim 1 wherein the carburetor is elevated with respect to the fuel tank such that the step of permitting flow of fuel out is enabled by gravity flow of fuel.

6. The method of claim 5 wherein the receptacle is the fuel tank.

7. The method of claim 1 wherein the receptacle is separate from the fuel tank.

8. The method of claim 7 further comprising permitting flow of fuel from the receptacle to at least one of the fuel tank, the carburetor, or a fluid path therebetween, substantially during startup of the engine.

9. The method of claim 8 further comprising pumping fuel from the receptacle with a pneumatically-actuated diaphragm pump.

10. The method of claim 1 further comprising:
permitting flow of fuel vapor into the carburetor, at least when the internal combustion engine is operating; and
preventing flow of fuel vapor into the carburetor, at least when the internal combustion engine is not operating.

11.-21. (canceled)

22. A carburetor of a fuel system that includes a fuel tank for containing fuel and that is adapted for use with an internal combustion engine, the carburetor comprising:
a body for mixing air with fuel for delivery to the engine;
a float carried by the body and being movable about a pivot axis; and
a fuel bowl carried by the body, wherein a fuel chamber is defined therebetween for containing fuel, the fuel bowl includes a closed end having an inside bottom surface sloped generally downwardly away from the pivot axis and further having a low-lying collection area and a fuel drain outlet disposed substantially at the low-lying collection area to enable substantially complete drainage of fuel out of the fuel bowl.

23. The carburetor of claim 22 wherein the fuel bowl includes a drain channel provided in the inside bottom surface and in communication with the low-lying collection area.

24. A fuel bowl for containing fuel for a carburetor, comprising:
an open end;
a wall portion extending from the open end; and
a closed end terminating the wall portion, the closed end including a low-lying collection area and a fuel drain outlet disposed substantially at the low-lying collection area to enable substantially complete drainage of fuel out of the fuel bowl.

25. The fuel bowl of claim 24 wherein the closed end further includes an inside bottom surface that is sloped substantially toward the low-lying collection area.

26. The fuel bowl of claim 25 wherein the closed end further includes a drain channel provided in the inside bottom surface and in communication with the low-lying collection area.

27. A fuel pump of a fuel system including a fuel tank and a carburetor adapted for use with an internal combustion engine, comprising:
a diaphragm disposed within an interior of the fuel pump to divide the interior into a fuel reservoir on a reservoir side of the diaphragm and an oppositely disposed actuation chamber on an actuation side of the diaphragm;
a biasing member to yieldably bias the diaphragm;
a fuel inlet in communication with the fuel reservoir;
an inlet check valve in communication with the fuel inlet;
a fuel outlet in communication with the fuel reservoir; and
an outlet check valve in communication with the fuel outlet.

28. The fuel pump of claim 27 further comprising:
a housing; and
a cover carried by the housing to define the interior therebetween, the diaphragm being sealingly engaged between the housing and the cover.

29. The fuel pump of claim 28 further comprising a vacuum pump mounted to the cover and being adapted to convert vacuum pulses received from an external source into pressure pulses to pressurize the actuation chamber.

30. The fuel pump of claim 29 wherein the vacuum pump comprises:
a valve plate positioned against the cover;
a diaphragm plate positioned against the valve plate;
a valve diaphragm positioned between the valve plate and diaphragm plate and including an inlet valve and an outlet valve;
a cover positioned against the diaphragm plate;
a diaphragm positioned between the cover and the diaphragm plate; and
a biasing means positioned between the diaphragm and the cover.

31. The fuel pump of claim 28 further comprising a plunger apparatus carried by the cover and being adapted to convert push-pull motion into displacement of the diaphragm.

32. The fuel pump of claim 31 wherein the plunger apparatus comprises:
a plunger including a plate portion positioned against the diaphragm and a stem portion extending from the plate portion through an aperture in the cover; and
a biasing member positioned between the plate portion of the plunger and the cover.

33. The fuel pump of claim 28 further comprising a valve actuation device mounted to the housing and being in fluid communication between the fuel tank and the fuel chamber of the carburetor, wherein the valve actuation device permits flow of fuel from the fuel tank to the carburetor when the internal combustion engine is operating, and further wherein the valve actuation device prevents flow of fuel from the fuel tank to the carburetor when the internal combustion engine is not operating.

34. The fuel pump of claim 33 wherein the valve actuation device comprises:
a valve plate positioned against the housing;
a cover positioned against the valve plate; and
a rotatable valve positioned between the cover and the valve plate, the rotatable valve being rotatably biased to a valve closed position so as to automatically stop flow of fuel through at least one passage.

35. The fuel pump of claim 28 wherein the cover includes a pressure port therein adapted to communicate pressurized air into and out of the actuation chamber.

36. A method of reducing evaporative emissions from a carburetor, which includes a fuel bowl, a fuel inlet passage in communication with the fuel bowl, an inlet valve to valve the inlet fuel passage, a float pivotable about a float pivot axis, and a fuel nozzle jet to communicate fuel within the fuel bowl to a fuel nozzle, the method comprising:
minimizing at least one of the size of the inlet fuel passage or the lateral distance between float pivot axis and at least one of the vertical axis of the inlet fuel passage or the inlet valve; and
maximizing at least one of the fuel contact surface area of the float or the lateral distance between the float pivot axis and a vertical axis of a fuel buoyancy force associated with the float;
wherein the volume of fuel within the fuel bowl is substantially minimized.

37. The method of claim 36 wherein the step of minimizing includes minimizing both the size of the inlet fuel passage and the lateral distance between float pivot axis and the axis of the inlet fuel passage.

38. The method of claim 37 wherein the step of maximizing includes maximizing both the fuel contact surface area of the float and the lateral distance between the float pivot axis and the vertical axis of the fuel buoyancy force associated with the float.

39. The method of claim 36 wherein the step of maximizing includes maximizing the fuel contact surface area of the float and the lateral distance between the float pivot axis and the fuel buoyancy force associated with the float.

40. The method of claim 39 wherein the step of minimizing includes minimizing both the size of the inlet fuel passage and the lateral distance between float pivot axis and the axis of the inlet fuel passage.

41. The method of claim 36 further comprising:
angling an inside bottom surface of the fuel bowl.

42. The method of claim 41 further comprising:
angling the inside bottom surface of the fuel bowl laterally and downwardly away from the float pivot axis.

43. The method of claim 42 further comprising:
angling the inside bottom surface of the fuel bowl toward a low-lying collection area of the fuel bowl.

44. (canceled)
